(19) United States
(12) Patent Application Publication
(10) Pub. No.: US 2019/0215463 A1
(43) Pub. Date: Jul. 11, 2019

(54) ACTUATOR AND CAMERA DEVICE

(71) Applicant: PANASONIC INTELLECTUAL PROPERTY MANAGEMENT CO., LTD., Osaka (JP)

(72) Inventors: Hideki SHIRANE, Osaka (JP); Hironori TOMITA, Nara (JP); Teruyuki TAKIZAWA, Osaka (JP)

(21) Appl. No.: 16/355,183

(22) Filed: Mar. 15, 2019

Related U.S. Application Data
(63) Continuation of application No. PCT/JP2017/032509, filed on Sep. 8, 2017.

(30) Foreign Application Priority Data
Sep. 16, 2016 (JP) 2016-181786

(51) Int. Cl. H04N 5/232; G03B 17/56; H02K 11/215; H02K 41/035; G06T 7/70

(52) U.S. Cl. CPC H04N 5/23299; G03B 17/561; H02K 2201/18; H02K 41/0358; G06T 7/70; H02K 11/215

(57) ABSTRACT

A drive controller of an actuator controls rotation in Pitch direction of a holder in accordance with results of detection by a first magnetic sensor and a first gyrosensor. The drive controller also controls rotation in Yaw direction of the holder in accordance with results of detection by a second magnetic sensor and a second gyrosensor. The drive controller further controls rotation in Roll direction of the holder in accordance with a result of detection by a third gyrosensor.

### TECHNICAL FIELD

The present disclosure relates to an actuator and a camera device, and more particularly relates to an actuator and camera device configured to drive an object to be driven in rotation.

### BACKGROUND ART

A camera driver has been known in the art as a device for rotating a camera as an object to be driven (see, for example, Japanese Patent No. 5802192 (hereinafter referred to as D1)). The camera driver of D1 includes a movable unit to mount a camera thereon, a fixed unit, a first driving unit, a second driving unit, and a detector. The first driving unit electromagnetically drives the movable unit in rotation in a panning direction (in Yaw direction) and a tilting direction (in Pitch direction) with respect to the fixed unit. The second driving unit electromagnetically drives the movable unit in rotation in a rolling direction (in Roll direction) with respect to the fixed unit. The detector includes a tilt detecting magnet held opposite from the camera by the movable unit and a first magnetic sensor held by the fixed unit, and detects the angles of rotation in the panning and tilting directions of the movable unit. The detector further includes a pair of second magnetic sensors held by the fixed unit and a pair of rotation detecting magnets held by the movable unit.

Such a camera driver (actuator) requires the pair of second magnetic sensors and the pair of rotation detecting magnets to detect the angle of rotation in the Roll direction. There is a growing demand from consumers for controlling the rotational drive in the three directions while reducing the number of parts required to detect the angle of rotation in the Roll direction.

### SUMMARY

The present disclosure provides an actuator and camera device with the ability to control the rotational drive of the movable unit in the three directions with respect to the fixed unit, while reducing the number of parts required to detect the angle of rotation in the Roll direction.

An actuator according to an aspect of the present disclosure includes a holder, a fixed holder, a first drive, a second drive, a third drive, a first position detector, a second position detector, a first gyrosensor, a second gyrosensor, a third gyrosensor, and a drive controller. The holder holds an object to be driven thereon. The fixed holder holds the holder so as to allow the holder to rotate around a first axis, a second axis, and a third axis that are perpendicular to each other. The first drive drives the holder in rotation in Pitch direction around the first axis. The second drive drives the holder in rotation in Yaw direction around the second axis. The third drive drives the holder in rotation in Roll direction around the third axis. The first position detector is provided for the fixed holder to detect a rotational position in the Pitch direction of the holder with respect to the fixed holder. The second position detector is provided for the fixed holder to detect a rotational position in the Yaw direction of the holder with respect to the fixed holder. The first gyrosensor detects an angular velocity in the Pitch direction of the holder. The second gyrosensor detects an angular velocity in the Yaw direction of the holder. The third gyrosensor is provided for the holder to detect an angular velocity in the Roll direction of the holder. The drive controller controls rotation of the holder by controlling the first drive in accordance with results of detection by the first position detector and the first gyrosensor, controlling the second drive in accordance with results of detection by the second position detector and the second gyrosensor, and controlling the third drive in accordance with a result of detection by the third gyrosensor.

A camera device according to another aspect of the present disclosure includes: the actuator described above; and a camera module as the object to be driven.

### BRIEF DESCRIPTION OF DRAWINGS

FIG. 1 is a block diagram illustrating a configuration for an actuator according to a first embodiment of the present disclosure;

FIG. 2A is a perspective view of a camera device including the actuator;

FIG. 2B is a cross-sectional view, taken along the plane X-X (Y-Y), of the camera device;

FIG. 3 is an exploded perspective view of the camera device;

FIG. 4 is an exploded perspective view of a movable unit included in the actuator;

FIG. 5 illustrates an arrangement of magnetic sensors included in the actuator;

FIG. 6A is a cross-sectional view illustrating an exemplary situation where the actuator has tilted in Pitch direction;

FIG. 6B is a cross-sectional view illustrating a situation where the movable unit has been driven in rotation in the Pitch direction from the state shown in FIG. 6A;

FIG. 7A is a cross-sectional view illustrating another exemplary situation where the actuator has tilted in Pitch direction;

FIG. 7B is a cross-sectional view illustrating a situation where the movable unit has been driven in rotation in the Pitch direction from the state shown in FIG. 7A;

FIG. 8 is a block diagram illustrating a configuration for an actuator according to a second embodiment of the present disclosure;

FIG. 9A is a block diagram illustrating a configuration for a first correction unit included in the actuator;

FIG. 9B is a block diagram illustrating a configuration for a second correction unit included in the actuator;

FIG. 9C is a block diagram illustrating a configuration for a third correction unit included in the actuator;

FIG. 10A shows a situation where AC components are filtered out of a signal with only a low-pass filter;

FIG. 10B shows a situation where AC components are filtered out of a signal with a low-pass filter and through averaging processing;

FIG. 11 is a block diagram illustrating a configuration for a camera device according to a third embodiment of the present disclosure;

FIG. 12 is a block diagram illustrating a configuration for an actuator and an image processing unit included in the camera device;

FIG. 13A is a block diagram illustrating a configuration for a first processing unit included in the image processing unit of the camera device; and

FIG. 13B is a block diagram illustrating a configuration for a second processing unit included in the image processing unit of the camera device.

### DESCRIPTION OF EMBODIMENTS

Note that embodiments and their variations to be described below are only examples of the present disclosure and should not be construed as limiting. Rather, those embodiments and variations may be readily modified in various manners depending on a design choice or any other factor without departing from a true spirit and scope of the present disclosure.

(First Embodiment)

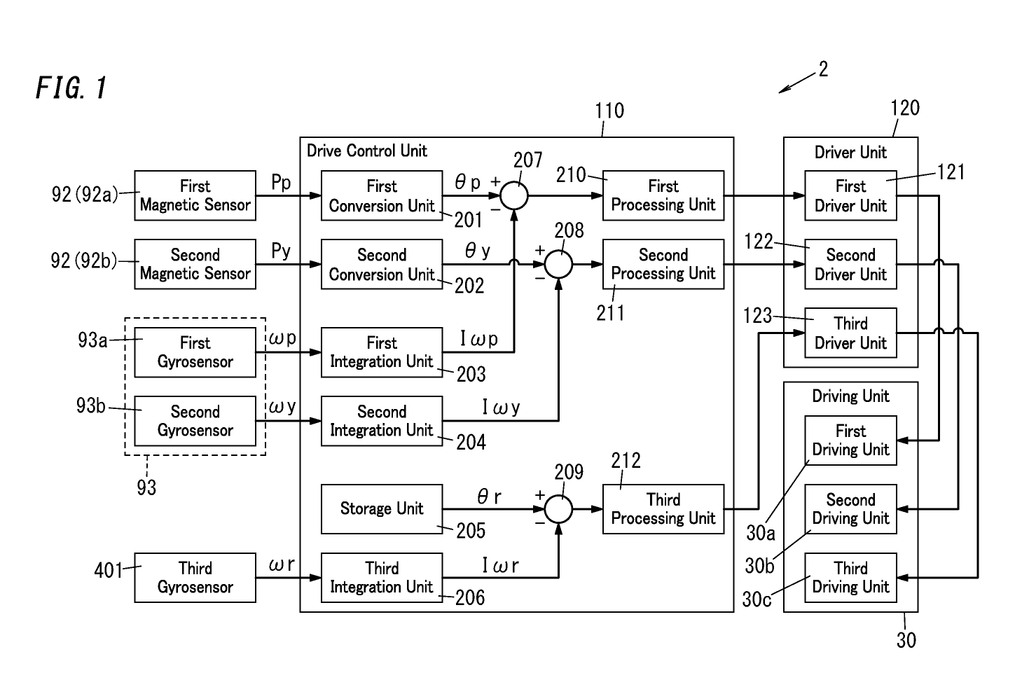

A camera device 1 according to this embodiment will be described with reference to FIGS. 1-7B.

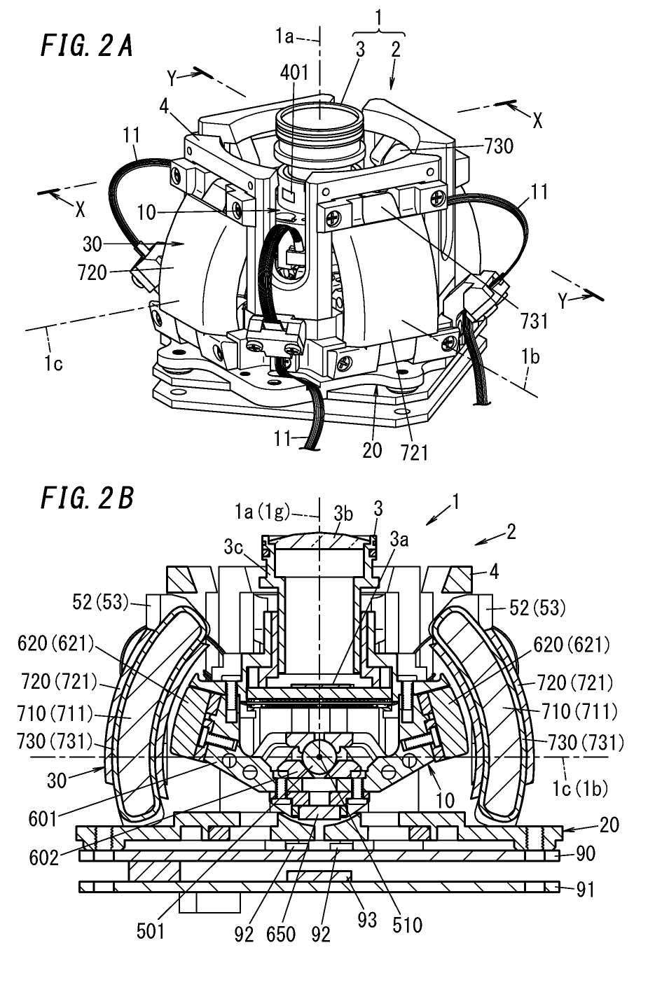

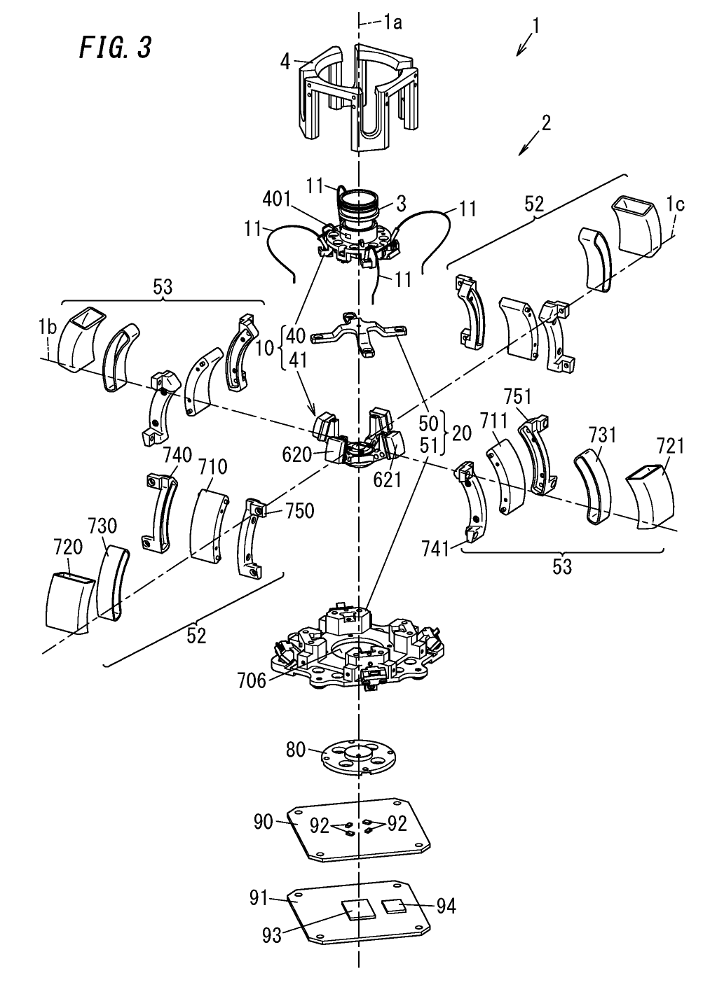

The camera device 1 may be a portable camera, for example, and includes an actuator 2 and a camera module 3 as shown in FIGS. 2A-3.

The camera module 3 includes an image capture device 3a, a lens 3b to form a subject image on an image capturing plane of the image capture device 3a, and a lens barrel 3c to hold the lens 3b. The camera module 3 converts video produced on the image capturing plane of the image capture device 3a into an electrical signal. Also, a plurality of cables to transmit the electrical signal generated by the image capture device 3a to an external image processor circuit (as an exemplary external circuit) are electrically connected to the camera module 3 via connectors. In this embodiment, the plurality of cables are fine-line coaxial cables of the same length, and the number of cables provided is forty. Those cables (forty cables) are grouped into four bundles of cables 11, each consisting of ten cables. Note that the number of the cables provided (e.g., forty) is only an example and should not be construed as limiting.

The actuator 2 includes an upper ring 4, a movable unit 10, a fixed unit 20, a driving unit 30, a stopper member 80, a first printed circuit board 90, and a second printed circuit board 91 as shown in FIGS. 2A and 3.

The movable unit 10 includes a camera holder 40 and a movable base 41 (see FIG. 3). The movable unit 10 is fitted into the fixed unit 20 with some gap left between the movable unit 10 and the fixed unit 20. The movable unit 10 rotates (i.e., rolls) around the optical axis 1a of the lens of the camera module 3 with respect to the fixed unit 20. The movable unit 10 also rotates around an axis 1b and an axis 1c, both of which are perpendicular to the optical axis 1a, with respect to the fixed unit 20. In this case, the axis 1b and the axis 1c are both perpendicular to a fitting direction, in which the movable unit 10 is fitted into the fixed unit 20 while the movable unit 10 is not rotating. Furthermore, these axes 1b and 1c intersect with each other at right angles. A detailed configuration of the movable unit 10 will be described later. The camera module 3 has been mounted on the camera holder 40. The configuration of the movable base 41 will be described later. Rotating the movable unit 10 allows the camera module 3 to rotate. In this embodiment, when the optical axis 1a is perpendicular to both of the axes 1b and 1c, the movable unit 10 (i.e., the camera module 3) is defined to be in a neutral position. In the following description, the direction in which the movable unit 10 (camera module 3) rotates around the axis 1b is defined herein as “Pitch direction” and the direction in which the movable unit 10 (camera module 3) rotates around the axis 1c is defined herein as “Yaw direction.” Furthermore, the direction in which the movable unit 10 (camera module 3) rotates (or rolls) around the optical axis 1a is defined herein as “Roll direction.”

The fixed unit 20 includes a coupling member 50 and a body 51 (see FIG. 3).

The coupling member 50 includes four coupling bars extending from a center portion thereof. Each of the four coupling bars is generally perpendicular to two adjacent coupling bars. Also, each of the four coupling bars is bent such that the tip portion thereof is located below the center portion. The coupling member 50 is screwed onto the body 51 with the movable base 41 interposed between itself and the body 51. Specifically, the respective tip portions of the four coupling bars are screwed onto the body 51.

The fixed unit 20 includes a pair of first coil units 52 and a pair of second coil units 53 to make the movable unit 10 electromagnetically drivable and rotatable (see FIG. 3). The pair of first coil units 52 allows the movable unit 10 to rotate around the axis 1b, and the pair of second coil units 53 allows the movable unit 10 to rotate around the axis 1c.

The pair of first coil units 52 each include a first magnetic yoke 710 made of a magnetic material, drive coils 720 and 730, and magnetic yoke holders 740 and 750 (see FIG. 3). Each of the first magnetic yokes 710 has the shape of an arc, of which the center is defined by the center 510 of rotation (see FIG. 2B). The pair of drive coils 730 are each formed by winding a conductive wire around its associated first magnetic yoke 710, of which the winding direction is defined around the axis 1b, such that the pair of first driving magnets 620 (to be described later) are driven in rotation in the Roll direction. After each drive coil 730 has been formed around its associated first magnetic yoke 710, the magnetic yoke holders 740 and 750 are secured with screws onto the first magnetic yoke 710 on both sides of the magnetic yoke 710 along the axis 1b. Thereafter, the drive coils 720 are each formed by winding a conductive wire around its associated first magnetic yoke 710 such that its winding direction is defined around the optical axis 1a when the movable unit 10 is in the neutral position and that the pair of first driving magnets 620 are driven in rotation in the Pitch direction. Then, the pair of first coil units 52 are secured with screws onto the upper ring 4 and the body 51 so as to face each other along the axis 1c when viewed from the camera module 3 (see FIGS. 2A and 3). Note that in this embodiment, the winding direction of the coil is a direction in which the number of coil turns increases (e.g., in the axial direction in the case of a cylindrical coil).

The pair of second coil units 53 each include a second magnetic yoke 711 made of a magnetic material, drive coils 721 and 731, and magnetic yoke holders 741 and 751 (see FIG. 3). Each of the second magnetic yokes 711 has the shape of an arc, of which the center is defined by the center 510 of rotation (see FIG. 2B). The pair of drive coils 731 are each formed by winding a conductive wire around its associated second magnetic yoke 711, of which the winding direction is defined around the axis 1c, such that the pair of second driving magnets 621 (to be described later) are driven in rotation in the Roll direction. After each drive coil 731 has been formed around its associated second magnetic yoke 711, the magnetic yoke holders 741 and 751 are secured with screws onto the second magnetic yoke 711 on both sides of the magnetic yoke 711 along the axis 1c. Thereafter, the drive coils 721 are each formed by winding a conductive wire around its associated second magnetic yoke 711 such that its winding direction is defined around the optical axis 1a when the movable unit 10 is in the neutral position and that the pair of second driving magnets 621 are driven in rotation in the Yaw direction. Then, the pair of second coil units 53 are secured with screws onto the upper ring 4 and the body 51 so as to face each other along the axis 1b when viewed from the camera module 3 (see FIGS. 2A and 3).

The camera module 3 that has been mounted on the camera holder 40 is fixed onto the movable unit 10 with the coupling member 50 interposed between itself and the movable base 41. The upper ring 4 is secured with screws onto the body 51 to sandwich the camera module 3, fixed onto the movable unit 10, between itself and the body 51 (see FIG. 3).

The stopper member 80 is a non-magnetic member. To prevent the movable unit 10 from falling off, the stopper member 80 is secured with screws onto the other side, opposite from the side to which the coupling member 50 is secured, of the body 51, so as to close an opening 706 of the body 51.

The first printed circuit board 90 includes a plurality of (e.g., four) magnetic sensors 92 for detecting rotational positions in the Pitch and Yaw directions of the camera module 3. In this embodiment, the magnetic sensors 92 may be implemented as Hall elements, for example. On the first printed circuit board 90, further assembled is a circuit for controlling the amount of a current allowed to flow through the drive coils 720, 721, 730, and 731 (such as a circuit having the function of the driver unit 120 shown in FIG. 1).

On the second printed circuit board 91, assembled are a sensor chip 93 for detecting the angular velocities in the Pitch and Yaw directions of the camera module 3, a microcomputer (micro controller) 94, and other components (see FIG. 3). The sensor chip 93 includes a first gyrosensor 93a with the capability of detecting the angular velocity in the Pitch direction of the camera module 3 and a second gyrosensor 93b with the capability of detecting the angular velocity in the Yaw direction of the camera module 3 (see FIG. 1). The microcomputer 94 performs the functions of the drive control unit 110 shown in FIG. 1 by executing a program stored in the memory. In this embodiment, the program is stored in advance in the memory of the computer. Alternatively, the program may also be downloaded via a telecommunications line such as the Internet or distributed after having been stored on a storage medium such as a memory card. The drive control unit 110 will be described in detail later.

Next, detailed configurations for the camera holder 40 and the movable base 41 will be described.

The camera holder 40 includes a third gyrosensor 401 for detecting the angular velocity in the Roll direction of the movable unit 10 (see FIGS. 2A, 3, and 4).

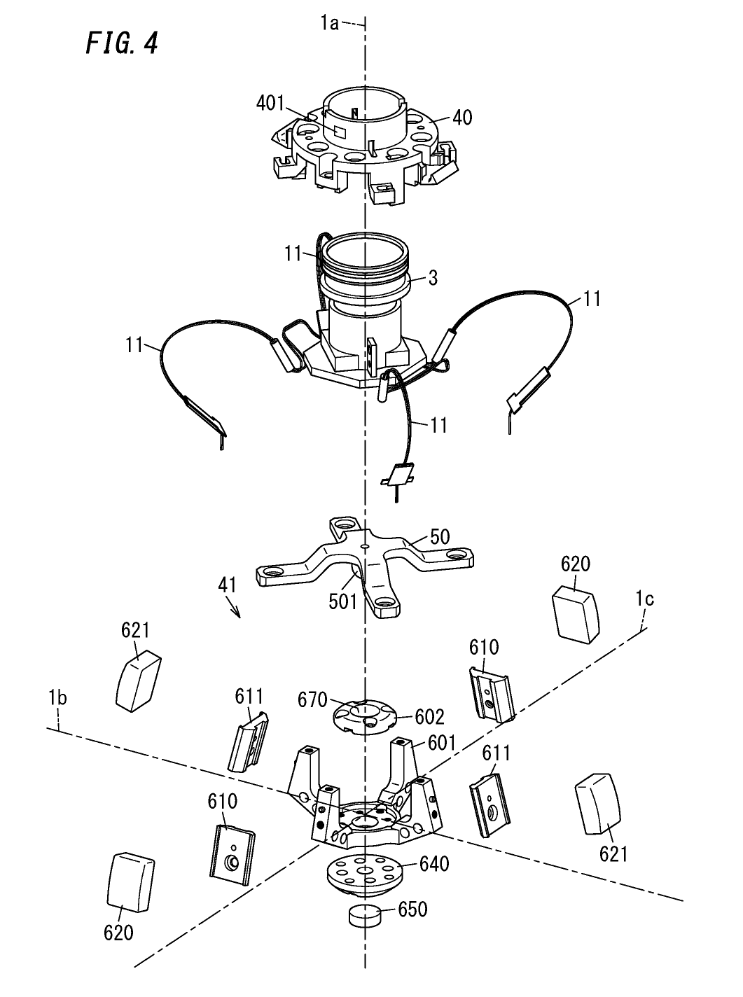

The movable base 41 has a loosely fitting space, and supports the camera module 3 thereon. The movable base 41 includes a body 601, a first loosely fitting member 602, a pair of first magnetic back yokes 610, a pair of second magnetic back yokes 611, a pair of first driving magnets 620, and a pair of second driving magnets 621 (see FIG. 4). The movable base 41 further includes a bottom plate 640 and a position detecting magnet 650 (see FIG. 4).

The body 601 includes a disk portion and four fixing portions (arms) protruding from the outer periphery of the disk portion toward the camera module 3 (i.e., upward). Two of the four fixing portions face each other along the axis 1b, and the other two fixing portions face each other along the axis 1c. Each of the four fixing portions has a generally L-shape, and will be hereinafter referred to as an “L-shaped fixing portion.” Each of these four L-shaped fixing portions faces, one to one, an associated one of the pair of first coil units 52 or an associated one of the pair of second coil units 53.

The first loosely fitting member 602 has a through hole in a tapered shape. The first loosely fitting member 602 has, as a first loosely fitting face 670, an inner peripheral face of the through hole in the tapered shape (see FIG. 4). The first loosely fitting member 602 is secured with screws onto the disk portion of the body 601 such that the first loosely fitting face 670 is exposed to the loosely fitting space.

The pair of first magnetic back yokes 610 are each provided one to one for an associated one of two, facing the pair of first coil units 52, out of the four L-shaped fixing portions. The pair of first magnetic back yokes 610 are secured with screws onto the two L-shaped fixing portions facing the pair of first coil units 52. The pair of second magnetic back yokes 611 are each provided one to one for an associated one of two, facing the pair of second coil units 53, out of the four L-shaped fixing portions. The pair of second magnetic back yokes 611 are secured with screws onto the two L-shaped fixing portions facing the pair of second coil units 53.

The pair of first driving magnets 620 are each provided one to one for an associated one of the pair of first magnetic back yokes 610. The pair of second driving magnets 621 are each provided one to one for an associated one of the pair of second magnetic back yokes 611. This allows the pair of first driving magnets 620 to face the pair of first coil units 52, and also allows the pair of second driving magnets 621 to face the pair of second coil units 53.

The bottom plate 640 is a non-magnetic member and may be made of brass, for example. The bottom plate 640 is provided for the other side, opposite from the side with the first loosely fitting member 602, of the body 601 to define the bottom of the movable unit 10 (i.e., the bottom of the movable base 41). The bottom plate 640 is secured with screws onto the body 601. The bottom plate 640 serves as a counterweight. Having the bottom plate 640 serve as a counterweight allows the center 510 of rotation to agree with the center of gravity of the movable unit 10. That is why when external force is applied to the entire movable unit 10, the moment of rotation of the movable unit 10 around the axis 1b and the moment of rotation of the movable unit 10 around the axis 1c both decrease. This allows the movable unit 10 (or the camera module 3) to be held in the neutral position, or to rotate around the axes 1b and 1c, with less driving force, thus reducing the power consumption of the camera device 1. Among other things, the amount of drive current to be supplied to hold the movable unit 10 in the neutral position may also be reduced to almost zero.

The position detecting magnet 650 is provided for a center portion of an exposed surface of the bottom plate 640.

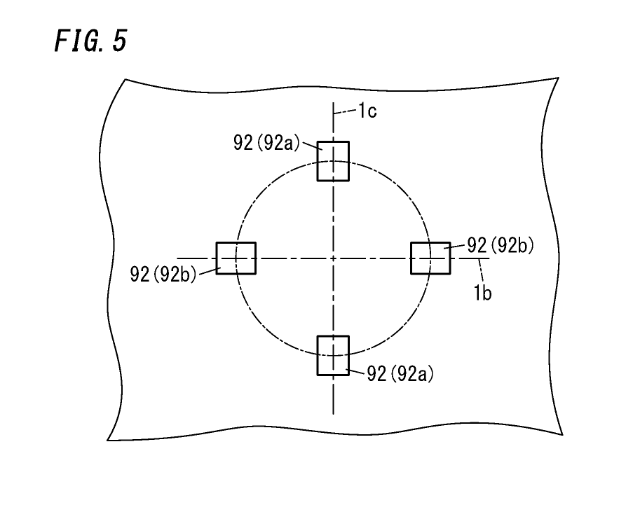

As the movable unit 10 rotates, the position detecting magnet 650 changes its position, thus causing a variation in the magnetic force applied to the four magnetic sensors 92 provided for the first printed circuit board 90. The four magnetic sensors 92 detect a variation, caused by the rotation of the position detecting magnet 650, in the magnetic force, and calculate two-dimensional angles of rotation with respect to the axes 1b and 1c. The four magnetic sensors 92 are arranged on the first printed circuit board 90 parallel to a plane including the axes 1b and 1c. Specifically, two of the four magnetic sensors 92 are arranged on the axis 1c to detect the rotational position in the Pitch direction of the movable unit 10 (see FIG. 5). The other two magnetic sensors 92 are arranged on the axis 1b to detect the rotational position in the Yaw direction of the movable unit 10 (see FIG. 5). In the following description, the two magnetic sensors 92 for detecting the rotational position in the Pitch direction will be collectively hereinafter referred to as “first magnetic sensors 92a (a first position detecting unit)” and the two magnetic sensors 92 for detecting the rotational position in the Yaw direction will be collectively hereinafter referred to as “second magnetic sensors 92b (a second position detecting unit).”

The coupling member 50 includes, at a center portion thereof (i.e., in a recess formed by respective bends of the four coupling bars), a second loosely fitting member 501 in a spherical shape (see FIGS. 2B and 4). The second loosely fitting member 501 has a second loosely fitting face with a raised spherical surface. The spherical second loosely fitting member 501 is bonded with an adhesive onto the center portion (recess) of the coupling member 50.

The coupling member 50 and the first loosely fitting member 602 are joined together. Specifically, the first loosely fitting face 670 of the first loosely fitting member 602 is brought into point or line contact with, and fitted with a narrow gap left onto, the second loosely fitting face of the second loosely fitting member 501. This allows the coupling member 50 to pivotally support the movable unit 10 so as to make the movable unit 10 freely rotatable. In this case, the center of the spherical second loosely fitting member 501 defines the center 510 of rotation.

The stopper member 80 has a recess, and is secured onto the body 51 such that a lower portion of the position detecting magnet 650 is introduced into the recess. A gap is left between the inner peripheral face of the recess of the stopper member 80 and the bottom of the bottom plate 640. The inner peripheral face of the recess of the stopper member 80 and the outer peripheral face of the bottom of the bottom plate 640 have curved faces that face each other. In this case, a gap is also left between the inner peripheral face of the recess of the stopper member 80 and the position detecting magnet 650. This gap is wide enough, even when the bottom plate 640 or the position detecting magnet 650 comes into contact with the stopper member 80, for the first driving magnets 620 and the second driving magnets 621 to return to their home positions due to their magnetism. This prevents, even when the camera module 3 is pressed toward the first printed circuit board 90, the camera module 3 from falling off, and also allows the pair of first driving magnets 620 and the pair of second driving magnets 621 to return to their home positions.

Note that the position detecting magnet 650 is suitably arranged inside of the outer periphery of the bottom of the bottom plate 640.

In this case, the pair of first driving magnets 620 serves as attracting magnets, thus producing first magnetic attraction forces between the pair of first driving magnets 620 and the first magnetic yokes 710 that face the first driving magnets 620. Likewise, the pair of second driving magnets 621 also serves as attracting magnets, thus producing second magnetic attraction forces between the pair of second driving magnets 621 and the second magnetic yokes 711 that face the second driving magnets 621. The vector direction of each of the first magnetic attraction forces is parallel to a centerline that connects together the center 510 of rotation, the center of mass of an associated one of the first magnetic yokes 710, and the center of mass of an associated one of the first driving magnets 620. The vector direction of each of the second magnetic attraction forces is parallel to a centerline that connects together the center 510 of rotation, the center of mass of an associated one of the second magnetic yokes 711, and the center of mass of an associated one of the second driving magnets 621.

The first and second magnetic attraction forces become normal forces produced by the second loosely fitting member 501 of the fixed unit 20 with respect to the first loosely fitting member 602. Also, when the movable unit 10 is in the neutral position, the magnetic attraction forces of the movable unit 10 define a synthetic vector along the optical axis 1a. This force balance between the first magnetic attraction forces, the second magnetic attraction forces, and the synthetic vector resembles the dynamic configuration of a balancing toy, and allows the movable unit 10 to rotate with good stability in three axis directions.

In this embodiment, the pair of first coil units 52, pair of second coil units 53, pair of first driving magnets 620, and pair of second driving magnets 621 described above together form the driving unit 30. The driving unit 30 includes a first driving unit 30a for rotating the movable unit 10 in the Pitch direction, a second driving unit 30b for rotating the movable unit 10 in the Yaw direction, and a third driving unit 30c for rotating the movable unit 10 in the Roll direction.

The first driving unit 30a includes the pair of first magnetic yokes 710 and pair of drive coils 720 (first drive coils) included in the pair of first coil units 52, and the pair of first driving magnets 620. The second driving unit 30b includes the pair of second magnetic yokes 711 and pair of drive coils 721 (second drive coils) included in the pair of second coil units 53, and the pair of second driving magnets 621. The third driving unit 30c includes the pair of first driving magnets 620, the pair of second driving magnets 621, the pair of first magnetic yokes 710, the pair of second magnetic yokes 711, the pair of drive coils 730 (third drive coils), and the pair of drive coils 731 (fourth drive coils).

The camera device 1 of this embodiment allows the movable unit 10 to rotate two-dimensionally (i.e., pitch and yaw) by supplying electricity to the pair of drive coils 720 and the pair of drive coils 721 simultaneously. In addition, the camera device 1 also allows the movable unit 10 to rotate (i.e., to roll) around the optical axis 1a by supplying electricity to the pair of drive coils 730 and the pair of drive coils 731 simultaneously.

Next, a functional configuration of the actuator 2 will be described.

As described above, the actuator 2 includes the first magnetic sensors 92a, the second magnetic sensors 92b, the first gyrosensor 93a, the second gyrosensor 93b, and the third gyrosensor 401 (see FIGS. 1, 2B, and 5). The actuator 2 further includes the drive control unit 110, the driver unit 120, and the driving unit 30 (see FIG. 1).

First, the drive control unit 110 and the driver unit 120 will be described.

The function of the drive control unit 110 is performed by the microcomputer 94 executing the program, as described above. The drive control unit 110 includes a first conversion unit 201, a second conversion unit 202, a first integration unit 203, a second integration unit 204, a storage unit 205, and a third integration unit 206 as shown in FIG. 1. The drive control unit 110 further includes a first arithmetic element 207, a second arithmetic element 208, a third arithmetic element 209, a first processing unit 210, a second processing unit 211, and a third processing unit 212 as shown in FIG. 1.

The first conversion unit 201 converts the rotational position Pp in the Pitch direction, detected by the first magnetic sensors 92a, of the movable unit 10 into the tilt angle (angle of rotation) θp in the Pitch direction of the movable unit 10.

The second conversion unit 202 converts the rotational position Py in the Yaw direction, detected by the second magnetic sensors 92b, of the movable unit 10 into the tilt angle (angle of rotation) θy in the Yaw direction of the movable unit 10.

The first integration unit 203 calculates the integral of the angular velocities ωp in the Pitch direction, detected by the first gyrosensor 93a, to convert the integral of the angular velocities ωp into an angle Iωp (first angle of rotation) in the Pitch direction.

The second integration unit 204 calculates the integral of the angular velocities ωy in the Yaw direction, detected by the second gyrosensor 93b, to convert the integral of the angular velocities ωy into an angle Iωy (second angle of rotation) in the Yaw direction.

The storage unit 205 stores in advance information representing a reference position (predetermined position) in the Roll direction of the movable unit 10. The reference position may be, for example, a position in the Roll direction where the movable unit 10 has an angle of rotation of 0 degrees.

The third integration unit 206 calculates the integral of the angular velocities ωr in the Roll direction, detected by the third gyrosensor 401, to convert the integral of the angular velocities ωr into an angle Iωr (third angle of rotation) in the Roll direction.

The first arithmetic element 207 receives, as input values, the angle θp from the first conversion unit 201 and the angle Iωp from the first integration unit 203 and calculates, based on these input values, a first differential value for controlling the movable unit 10 with respect to the Pitch direction.

The second arithmetic element 208 receives, as input values, the angle θy from the second conversion unit 202 and the angle Iωy from the second integration unit 204 and calculates, based on these input values, a second differential value for controlling the movable unit 10 with respect to the Yaw direction.

The third arithmetic element 209 receives, as input values, information, stored in the storage unit 205, about the reference position and the angle Iωr from the third integration unit 206 and calculates, based on these input values, a third differential value for controlling the movable unit 10 with respect to the Roll direction.

The first processing unit 210 subjects the first differential value to proportional-integral-differential (PID) control to generate a first control signal for controlling the amount of a current supplied to the pair of drive coils 720 included in the first driving unit 30a. As used herein, the PID control is a control method for controlling an output value based on the deviation of the output value from its target value through integration and differentiation.

The second processing unit 211 subjects the second differential value to the PID control to generate a second control signal for controlling the amount of a current supplied to the pair of drive coils 721 included in the second driving unit 30b.

The third processing unit 212 subjects the third differential value to the PID control to generate a third control signal for controlling the amount of a current supplied to the pair of drive coils 730 and pair of drive coils 731 included in the third driving unit 30c.

The driver unit 120 includes a first driver unit 121, a second driver unit 122, and a third driver unit 123. The first driver unit 121 controls output of a signal to a first driving unit 30a. The second driver unit 122 controls output of a signal to a second driving unit 30b. The third driver unit 123 controls output of a signal to a third driving unit 30c.

Next, it will be described with reference to FIG. 1 how the actuator 2 operates. In this embodiment, the drive control unit 110 is sequentially loaded with results of detection by the magnetic sensors 92, the sensor chip 93, and the third gyrosensor 401 and performs control arithmetic operation. In the following description, it will be described how to control, in a situation where the orientation of the camera device 1 has changed due to a camera shake, for example, while the camera device 1 is facing a predetermined direction, the orientation of the camera module 3 toward the original orientation. In the following description, it will be described how to perform the control arithmetic operation in the three directions (namely, the Pitch, Yaw, and Roll directions).

The first magnetic sensors 92a output, on detecting the rotational position Pp in the Pitch direction of the movable unit 10, the rotational position Pp as a result of detection to the drive control unit 110. The first conversion unit 201 of the drive control unit 110 converts, on receiving the rotational position Pp in the Pitch direction of the movable unit 10 from the first magnetic sensors 92a, the rotational position Pp into an angle θp and outputs the angle θp to the first arithmetic element 207.

The first gyrosensor 93a outputs, on detecting the angular velocity ωp in the Pitch direction of the movable unit 10, the angular velocity ωp as a result of detection to the drive control unit 110. The first integration unit 203 of the drive control unit 110 performs, on receiving the angular velocity ωp in the Pitch direction of the movable unit 10 from the first gyrosensor 93a, integration operation on the angular velocity ωp to convert the angular velocity ωp into an angle Iωp and output the angle Iωp to the first arithmetic element 207.

The first arithmetic element 207 subtracts the angle Iωp from the angle θp and outputs the result of subtraction to the first processing unit 210. The first processing unit 210 subjects the result of subtraction obtained by the first arithmetic element 207 to the PID control, thus generating a first control signal.

The first driver unit 121 outputs the first control signal to the pair of drive coils 720 to drive the movable unit 10 in rotation in the Pitch direction.

The second magnetic sensors 92b output, on detecting the rotational position Py in the Yaw direction of the movable unit 10, the rotational position Py as a result of detection to the drive control unit 110. The second conversion unit 202 of the drive control unit 110 converts, on receiving the rotational position Py in the Yaw direction of the movable unit 10 from the second magnetic sensors 92b, the rotational position Py into an angle θy and outputs the angle θy to the second arithmetic element 208.

The second gyrosensor 93b outputs, on detecting the angular velocity ωy in the Yaw direction of the movable unit 10, the angular velocity ωy as a result of detection to the drive control unit 110. The second integration unit 204 of the drive control unit 110 performs, on receiving the angular velocity ωy in the Yaw direction of the movable unit 10 from the second gyrosensor 93b, integration operation on the angular velocity ωy to convert the angular velocity ωy into an angle Iωy and output the angle Iωy to the second arithmetic element 208.

The second arithmetic element 208 subtracts the angle Iωy from the angle θy and outputs the result of subtraction to the second processing unit 211. The second processing unit 211 subjects the result of subtraction obtained by the second arithmetic element 208 to the PID control, thus generating a second control signal.

The second driver unit 122 outputs the second control signal to the pair of drive coils 721 to drive the movable unit 10 in rotation in the Yaw direction.

The third gyrosensor 401 outputs, on detecting the angular velocity ωr in the Roll direction of the movable unit 10, the angular velocity ωr as a result of detection to the drive control unit 110. The third integration unit 206 of the drive control unit 110 performs, on receiving the angular velocity ωr in the Roll direction of the movable unit 10 from the third gyrosensor 401, integration operation on the angular velocity ωr to convert the angular velocity ωr into an angle Iωr and output the angle Iωr to the third arithmetic element 209.

The third arithmetic element 209 subtracts the angle Iωr from the information (angle θr), stored in the storage unit 205, about the reference position (predetermined position) and outputs the result of subtraction to the third processing unit 212. The third processing unit 212 subjects the result of subtraction obtained by the third arithmetic element 209 to the PID control, thus generating a third control signal.

The third driver unit 123 outputs the third control signal to the pair of drive coils 730 and the pair of drive coils 731 to drive the movable unit 10 in rotation in the Roll direction.

As can be seen from the foregoing description, the actuator 2 is able to correct the position of the movable unit 10 (camera module 3) to its original position before the rotation according to the tri-axial rotational positions of the movable unit 10 (camera module 3). That is to say, even if the user of the camera device 1 has tilted the camera device 1 unintentionally, the actuator 2 is still able to bring the camera module 3 back to the original condition before the camera device 1 has been tilted. This allows the actuator 2 to compensate for a camera shake due to the user's hand tremors.

Next, a specific operation of the actuator 2 will be described with reference to FIG. 2B and FIGS. 6A-7B.

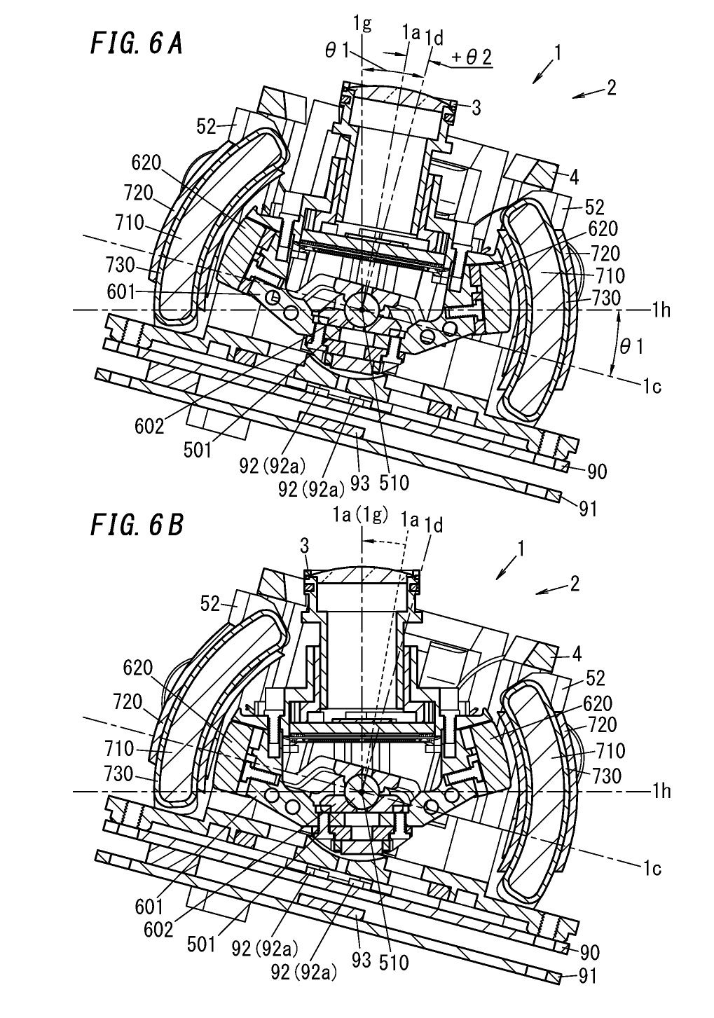

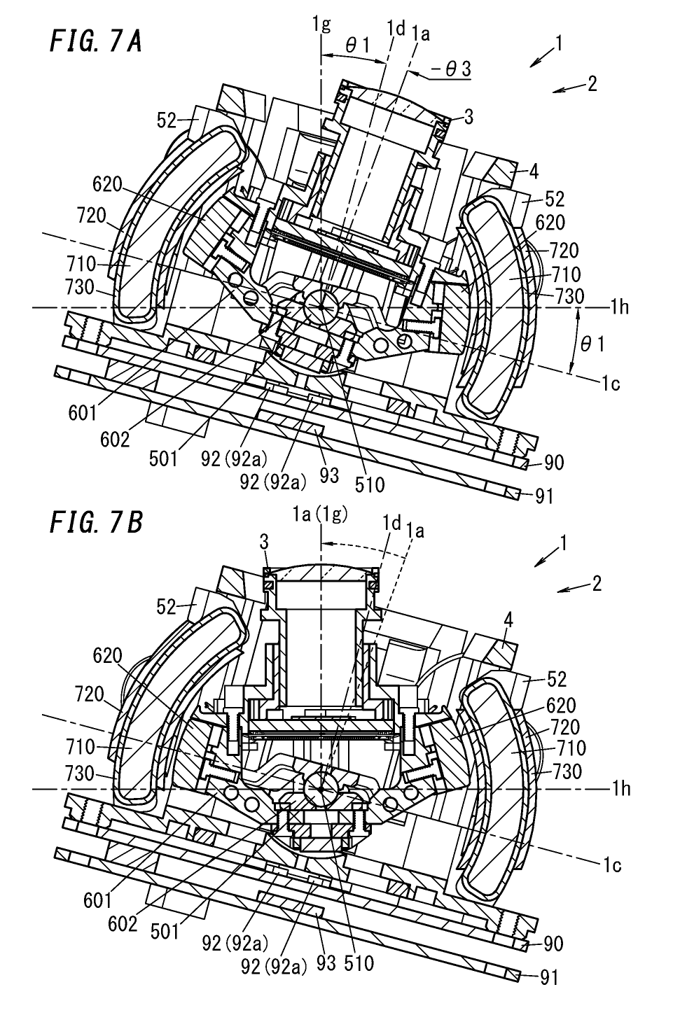

In this specific example, the actuator 2 is supposed to have the movable unit 10 (camera module 3) held in a neutral position as shown in FIG. 2B such that the optical axis 1a of the camera module 3 is aligned with the vertical line 1g. The vertical line 1g is a line extending in the gravitational direction and passing through the center of the second loosing fitting member 501 (i.e., the center of rotation 510). In this case, the axis 1c is aligned with, for example, a horizontal line 1h (see FIGS. 6A-7B) that passes through the center 510 and that is perpendicular to the vertical line 1g.

Suppose the camera device 1 has been tilted from the position shown in FIG. 2B by an angle θ1 with respect to the horizontal line 1h (i.e., tilted by the angle θ1 in the Pitch direction (see FIG. 6A)). At this time, the angle formed between the vertical line 1g and a normal 1d to the axis 1c is θ1. The drive control unit 110 performs integration operation on the result of detection by the first gyrosensor 93a to calculate the angle θ1.

The movable unit 10 is fixed to the fixed unit 20 by the first magnetic attraction forces, the second magnetic attraction forces, and the synthetic vector, as described above. That is to say, the movable unit 10 is not completely fixed to the fixed unit 20, and therefore, does not always follow the tilt of the camera device 1 tilting. That is why the result of detection by the first magnetic sensors 92a could disagree with the angle obtained from the result of detection by the first gyrosensor 93a. For example, the optical axis 1a could be present between the normal 1d and the vertical line 1g. In that case, the first magnetic sensors 92a detect, as the result of detection, the angle θ2 formed between the optical axis 1a and the normal 1d (see FIG. 6A). Note that the first magnetic sensors 92a detect an angle defined from the normal 1d toward the vertical line 1g as a positive value and also detect an angle defined from the normal 1d toward the horizontal line 1h as a negative value. In FIG. 6A, the angle θ2 is a positive value.

The first arithmetic element 207 subtracts the angle θ1 from the angle θ2. The first processing unit 210 generates, based on the result of subtraction (θ2−θ1), a signal for controlling the rotation of the movable unit 10 (first control signal) such that the optical axis 1a is aligned with the vertical line 1g.

The first driving unit 30a of the driving unit 30 drives, in accordance with the first control signal, the movable unit 10 in rotation in the Pitch direction. This allows the actuator 2 to align the optical axis 1a of the camera module 3 with the vertical line 1g, i.e., the gravitational direction, as shown in FIG. 6B. That is to say, this allows the actuator 2 to bring the optical axis 1a back to the state before the camera device 1 has been tilted by the angle θ1 with respect to the horizontal line 1h.

In another example, the optical axis 1a could be present between the normal 1d and the horizontal line 1h. In that case, the first magnetic sensors 92a detect, as the result of detection, the angle θ3 formed between the optical axis 1a and the normal 1d (see FIG. 7A). In this case, the angle θ3 has a negative value because the first magnetic sensors 92a detect the angle defined from the normal 1d toward the horizontal line 1h as a negative value, as described above. In the following description, the angle θ3 will be hereinafter referred to as “−θ3” to clearly indicate that θ3 is a negative value.

The first arithmetic element 207 subtracts the angle θ1 from the result of detection (−θ3) obtained by the first magnetic sensors 92a. The first processing unit 210 generates, based on the result of subtraction (−θ3−θ1), a signal for controlling the rotation of the movable unit 10 (first control signal) such that the optical axis 1a is aligned with the vertical line 1g.

The first driving unit 30a of the driving unit 30 drives, in accordance with the first control signal, the movable unit 10 in rotation in the Pitch direction. This allows the actuator 2 to align the optical axis 1a of the camera module 3 with the vertical line 1g, i.e., the gravitational direction, as shown in FIG. 7B. That is to say, this allows the actuator 2 to bring the optical axis 1a back to the state before the camera device 1 has been tilted by the angle θ1 with respect to the horizontal line 1h.

(Second Embodiment)

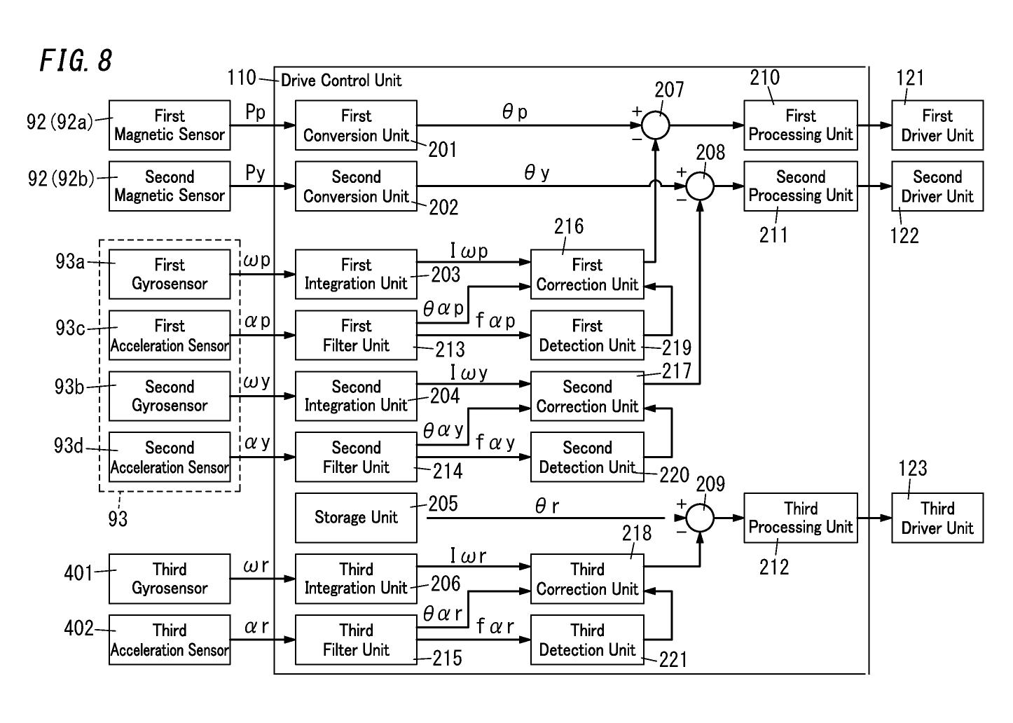

A camera device 1 according to a second embodiment further includes acceleration sensors, which is a major difference from the first embodiment. A camera device 1 according to the second embodiment will be described with reference to FIGS. 8-10B. The following description of the second embodiment will be focused on the differences from the first embodiment. Also, in the following description, any constituent member of the second embodiment having the same function as a counterpart of the first embodiment described above will be designated by the same reference numeral as that counterpart's, and description thereof will be omitted herein as appropriate.

The sensor chip 93 of the camera device 1 according to this embodiment includes not only the first gyrosensor 93a and the second gyrosensor 93b but also a first acceleration sensor 93c and a second acceleration sensor 93d as well as shown in FIG. 8. The camera device 1 of this embodiment further includes a third acceleration sensor 402.

The first acceleration sensor 93c is a sensor with the ability to detect the acceleration applied in the Pitch direction to the movable unit 10.

The second acceleration sensor 93d is a sensor with the ability to detect the acceleration applied in the Yaw direction to the movable unit 10.

The third acceleration sensor 402 is a sensor provided for the movable unit 10 and having the ability to detect the acceleration applied in the Roll direction to the movable unit 10.

The drive control unit 110 of this embodiment includes not only all of the functional constituent elements described for the first embodiment but also a first filter unit 213, a second filter unit 214, a third filter unit 215, a first correction unit 216, a second correction unit 217, and a third correction unit 218 as shown in FIG. 8. The drive control unit 110 further includes a first detection unit 219, a second detection unit 220, and a third detection unit 221.

The first filter unit 213 includes a low-pass filter. The first filter unit 213 has frequency components, higher than a predetermined frequency, of a signal representing the acceleration αp detected by the first acceleration sensor 93c, attenuated by the low-pass filter. The first filter unit 213 obtains a peak value and a bottom value of the signal (representing the acceleration αp) that has had its high frequency components attenuated. The first filter unit 213 outputs, as a tilt component (tilt direction) in the Pitch direction with respect to the gravitational direction, a first value fαp, which is an intermediate value between the peak value and the bottom value. This allows the first filter unit 213 to output a signal (i.e., a signal representing the first value fαp) obtained by removing a translational component (AC component) from the signal representing the acceleration αp detected by the first acceleration sensor 93c.

The second filter unit 214 includes a low-pass filter. The second filter unit 214 has frequency components, higher than a predetermined frequency, of a signal representing the acceleration αy detected by the second acceleration sensor 93d, attenuated by the low-pass filter. The second filter unit 214 obtains a peak value and a bottom value of the signal (representing the acceleration αy) that has had its high frequency components attenuated. The second filter unit 214 outputs, as a tilt component (tilt direction) in the Yaw direction with respect to the gravitational direction, a second value fαy, which is an intermediate value between the peak value and the bottom value. This allows the second filter unit 214 to output a signal (i.e., a signal representing the second value fαy) obtained by removing an AC component from the signal representing the acceleration αy detected by the second acceleration sensor 93d.

The third filter unit 215 includes a low-pass filter. The third filter unit 215 has frequency components, higher than a predetermined frequency, of a signal representing the acceleration αr detected by the third acceleration sensor 402, attenuated by the low-pass filter. The third filter unit 215 obtains a peak value and a bottom value of the signal (representing the acceleration αr) that has had its high frequency components attenuated. The third filter unit 215 outputs, as a tilt component (tilt direction) in the Roll direction with respect to the gravitational direction, a third value fαr, which is an intermediate value between the peak value and the bottom value. This allows the third filter unit 215 to output a signal (i.e., a signal representing the third value fαr) obtained by removing an AC component from the signal representing the acceleration αr detected by the third acceleration sensor 402.

The first filter unit 213 further calculates, based on the third value fαr generated by the third filter unit 215 and the second value fαy generated by the second filter unit 214, the angle (tilt angle) formed between the tilt direction in the Roll direction and the tilt direction in the Yaw direction, and outputs a first correction value θαp, representing the tilt angle, to the first correction unit 216.

The second filter unit 214 further calculates, based on the first value fαp generated by the first filter unit 213 and the third value fαr generated by the third filter unit 215, the angle (tilt angle) formed between the tilt direction in the Pitch direction and the tilt direction in the Roll direction, and outputs a second correction value θαy, representing the tilt angle, to the second correction unit 217.

The third filter unit 215 further calculates, based on the first value fαp generated by the first filter unit 213 and the second value fαy generated by the second filter unit 214, the angle (tilt angle) formed between the tilt direction in the Pitch direction and the tilt direction in the Yaw direction, and outputs a third correction value θαr, representing the tilt angle, to the third correction unit 218.

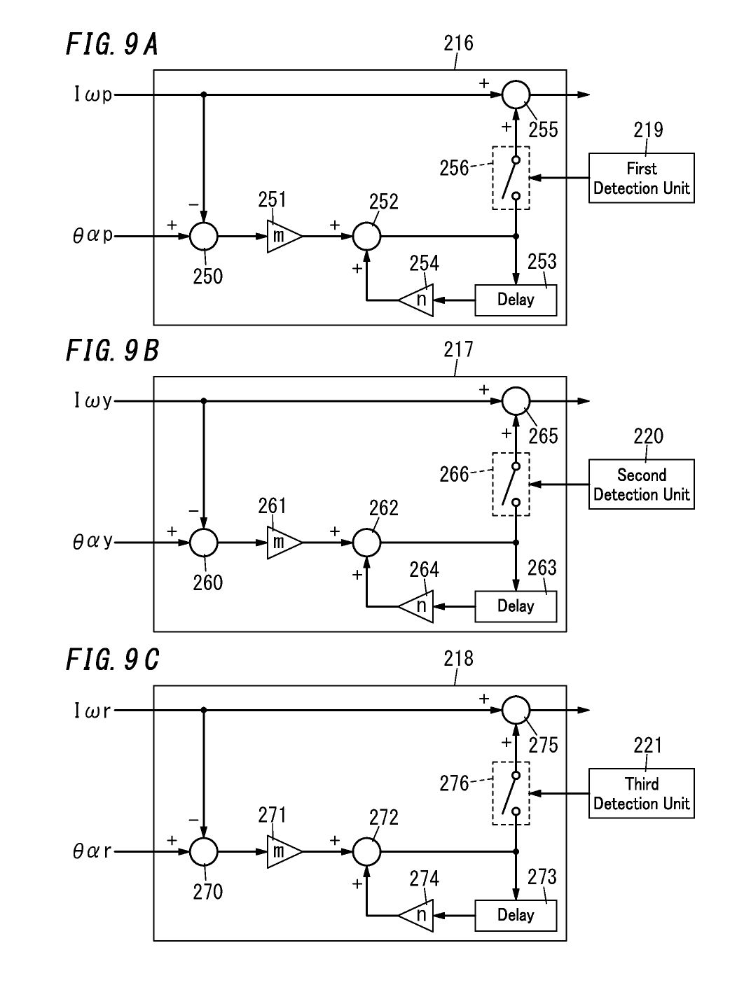

The first correction unit 216 corrects the angle Iωp calculated by the first integration unit 203 with the first correction value θαp output from the first filter unit 213. The first correction unit 216 includes two multipliers 251 and 254, three arithmetic elements 250, 252, and 255, a delay 253, and a switch 256 as shown in FIG. 9A.

The arithmetic element 250 subtracts the angle Iωp calculated by the first integration unit 203 from the first correction value θαp (tilt angle) calculated by the first filter unit 213 and outputs the result of subtraction. The multiplier 251 multiplies the result of subtraction obtained by the arithmetic element 250 by a value m and outputs the result of multiplication. The arithmetic element 252 adds a result of multiplication obtained by the multiplier 254 to the result of multiplication obtained by the multiplier 251 and output the result of addition. The delay 253 delays the phase of a signal representing the result of addition output from the arithmetic element 252. The multiplier 254 multiplies the result of addition, obtained by the arithmetic element 252 and output from the delay 253, by n and outputs the result of multiplication. The switch 256 switches between a first closed state and a first open state in accordance with an instruction from the first detection unit 219. As used herein, the first closed state refers to a state where the arithmetic element 252 and the delay 253 are electrically conductive with the arithmetic element 255. The first open state refers to a state where the arithmetic element 252 and the delay 253 are electrically non-conductive with the arithmetic element 255. The arithmetic element 255 adds, when the switch 256 is in the first closed state, the result of addition obtained by the arithmetic element 252 to the angle Iωp output from the first integration unit 203 and outputs the result of addition (corrected angle) to the first arithmetic element 207. On the other hand, when the switch 256 is in the first open state, the arithmetic element 255 just passes the angle Iωp, output from the first integration unit 203, to the first arithmetic element 207 without correcting the angle Iωp.

The first arithmetic element 207 subtracts the angle output from the first correction unit 216 from the angle θp output from the first conversion unit 201. This allows for calculating a more accurate angle in the Pitch direction to drive the movable unit 10 in rotation in the Pitch direction.

In this example, regarding the values m and n, the value m is suitably less than the value n and the sum (m+n) of these values m and n is suitably less than one. The reason is that if the sum (m+n) were greater than one, the correction value for correcting the angle Iωp, i.e., the result of addition obtained by the arithmetic element 252, could be greater than a value required for correction, which would not be beneficial. Setting the sum (m+n) at a value less than one and performing feedback control allows the result of addition obtained by the arithmetic element 252 to be gradually brought closer to the value required for correction. In addition, making the value n equal to or greater than the value m accelerates the convergence with which the result of addition obtained by the arithmetic element 252 reaches the value required for correction. In general, however, the result of detection obtained by an acceleration sensor has a significant translational component, and the degree of reliability of the result of detection is usually low. That is why the convergence with which the result of addition obtained by the arithmetic element 252 reaches the value required for correction is suitably decelerated by making the value m less than the value n.

The second correction unit 217 corrects the angle Iωy calculated by the second integration unit 204 with the second correction value bay output from the second filter unit 214. The second correction unit 217 includes two multipliers 261 and 264, three arithmetic elements 260, 262, and 265, a delay 263, and a switch 266 as shown in FIG. 9B.

The arithmetic element 260 subtracts the angle Iωy calculated by the second integration unit 204 from the second correction value θαy (tilt angle) calculated by the second filter unit 214 and outputs the result of subtraction. The multiplier 261 multiplies the result of subtraction obtained by the arithmetic element 260 by a value m and outputs the result of multiplication. The arithmetic element 262 adds a result of multiplication obtained by the multiplier 264 to the result of multiplication obtained by the multiplier 261 and output the result of addition. The delay 263 delays the phase of a signal representing the result of addition output from the arithmetic element 262. The multiplier 264 multiplies the result of addition, obtained by the arithmetic element 262 and output from the delay 263, by a value n and outputs the result of multiplication. The switch 266 switches between a second closed state and a second open state in accordance with an instruction from the second detection unit 220. As used herein, the second closed state refers to a state where the arithmetic element 262 and the delay 263 are electrically conductive with the arithmetic element 265. The second open state refers to a state where the arithmetic element 262 and the delay 263 are electrically non-conductive with the arithmetic element 265. The arithmetic element 265 adds, when the switch 266 is in the second closed state, the result of addition obtained by the arithmetic element 262 to the angle Iωy output from the second integration unit 204 and outputs the result of addition (corrected angle) to the second arithmetic element 208. On the other hand, when the switch 266 is in the second open state, the arithmetic element 265 just passes the angle Iωy, output from the second integration unit 204, to the second arithmetic element 208 without correcting the angle Iωy.

The second arithmetic element 208 subtracts the angle output from the second correction unit 217 from the angle θy output from the second conversion unit 202. This allows for calculating a more accurate angle in the Yaw direction to drive the movable unit 10 in rotation in the Yaw direction.

The third correction unit 218 corrects the angle Iωr calculated by the third integration unit 206 with the third correction value θαr output from the third filter unit 215. The third correction unit 218 includes two multipliers 271 and 274, three arithmetic elements 270, 272, and 275, a delay 273, and a switch 276 as shown in FIG. 9C.

The arithmetic element 270 subtracts the angle Iωr calculated by the third integration unit 206 from the third correction value θαr (tilt angle) calculated by the third filter unit 215 and outputs the result of subtraction. The multiplier 271 multiplies the result of subtraction obtained by the arithmetic element 270 by a value m and outputs the result of multiplication. The arithmetic element 272 adds a result of multiplication obtained by the multiplier 274 to the result of multiplication obtained by the multiplier 271 and output the result of addition. The delay 273 delays the phase of a signal representing the result of addition output from the arithmetic element 272. The multiplier 274 multiplies the result of addition, obtained by the arithmetic element 272 and output from the delay 273, by a value n and outputs the result of multiplication. The switch 276 switches between a third closed state and a third open state in accordance with an instruction from the third detection unit 221. As used herein, the third closed state refers to a state where the arithmetic element 272 and the delay 273 are electrically conductive with the arithmetic element 275. The third open state refers to a state where the arithmetic element 272 and the delay 273 are electrically non-conductive with the arithmetic element 275. The arithmetic element 275 adds, when the switch 276 is in the third closed state, the result of addition obtained by the arithmetic element 272 to the angle Iωr output from the third integration unit 206 and outputs the result of addition (corrected angle) to the third arithmetic element 209. On the other hand, when the switch 276 is in the third open state, the arithmetic element 275 just passes the angle Iωr, output from the third integration unit 206, to the third arithmetic element 209 without correcting the angle Iωr.

The third arithmetic element 209 subtracts the angle output from the third correction unit 218 from the information (angle θr), stored in the storage unit 205, about the reference position (predetermined position). This allows for calculating a more accurate angle in the Roll direction to drive the movable unit 10 in rotation in the Roll direction.

The first detection unit 219 detects, based on the first value fαp output from the first filter unit 213, the orientation (tilt) in the Pitch direction of the movable unit 10. Specifically, the first detection unit 219 detects the tilt in the Pitch direction of the rotational axis (axis 1b). The first detection unit 219 instructs, when the axis 1b is aligned with the gravitational direction, the switch 256 to turn into the first open state. When the axis 1b is not aligned with the gravitational direction, on the other hand, the first detection unit 219 instructs the switch 256 to turn into the first closed state.

The second detection unit 220 detects, based on the second value fαy output from the second filter unit 214, the orientation (tilt) in the Yaw direction of the movable unit 10. Specifically, the second detection unit 220 detects the tilt in the Yaw direction of the rotational axis (axis 1c). The second detection unit 220 instructs, when the axis 1c is aligned with the gravitational direction, the switch 266 to turn into the second open state. When the axis 1c is not aligned with the gravitational direction, on the other hand, the second detection unit 220 instructs the switch 266 to turn into the second closed state.

The third detection unit 221 detects, based on the third value fαr output from the third filter unit 215, the orientation (tilt) in the Roll direction of the movable unit 10. Specifically, the third detection unit 221 detects the tilt in the Roll direction of the rotational axis (optical axis 1a). The third detection unit 221 instructs, when the optical axis 1a is aligned with the gravitational direction, the switch 276 to turn into the third open state. When the optical axis 1a is not aligned with the gravitational direction, on the other hand, the third detection unit 221 instructs the switch 276 to turn into the third closed state.

Next, it will be described with reference to FIG. 8 how the actuator 2 operates. In this embodiment, the drive control unit 110 is sequentially loaded with results of detection by the magnetic sensors 92, the sensor chip 93, the third gyrosensor 401, and the third acceleration sensor 402 and performs control arithmetic operation. In the following description, it will be described how to control, in a situation where the orientation of the camera device 1 has changed due to a camera shake caused by the user's hand tremors, for example, while the camera device 1 is facing a predetermined direction, the orientation of the camera module 3 toward the original orientation. In the following description, it will be described how to perform the control arithmetic operation in the three directions (namely, the Pitch, Yaw, and Roll directions).

The first magnetic sensors 92a output, on detecting the rotational position Pp in the Pitch direction of the movable unit 10, the rotational position Pp as a result of detection to the drive control unit 110. The first conversion unit 201 of the drive control unit 110 converts the rotational position Pp into an angle θp and outputs the angle θp to the first arithmetic element 207.

The first gyrosensor 93a outputs, on detecting the angular velocity ωp in the Pitch direction of the movable unit 10, the angular velocity ωp as a result of detection to the drive control unit 110. The first integration unit 203 of the drive control unit 110 performs integration operation on the angular velocity ωp to convert the angular velocity ωp into an angle Iωp and output the angle Iωp to the first correction unit 216.

The first acceleration sensor 93c outputs, on detecting the acceleration αp in the Pitch direction to the movable unit 10, the acceleration αp detected to the first filter unit 213. The first filter unit 213 generates a first value fαp by removing an AC component from the acceleration αp. The first filter unit 213 generates a first correction value θαp based on a third value fαr generated by the third filter unit 215 and a second value fαy generated by the second filter unit 214 and outputs the first correction value θαp to the first correction unit 216.

The first correction unit 216 corrects the angle Iωp with the first correction value θαp to obtain a first correction value (corrected angle) and output the first correction value to the first arithmetic element 207.

The first arithmetic element 207 subtracts the first correction value from the angle θp and outputs the result of subtraction to the first processing unit 210.

The first detection unit 219 decides whether or not the axis 1b is aligned with the gravitational direction to control the switch 256. If the answer is NO, the first detection unit 219 controls the switch 256 such that the arithmetic element 255 adds the result of calculation obtained by the arithmetic element 252 to the angle Iωp output from the first integration unit 203 and outputs the result (corrected angle) to the first arithmetic element 207. On the other hand, if the answer is YES, then the first detection unit 219 controls the switch 256 such that the arithmetic element 255 outputs the angle Iωp, provided by the first integration unit 203, to the first arithmetic element 207.

The first processing unit 210 subjects the result of subtraction obtained by the first arithmetic element 207 to the PID control to generate a first control signal and output the first control signal to the first driver unit 121.

The first driver unit 121 outputs the first control signal to the pair of drive coils 720, thus driving the movable unit 10 in rotation in the Pitch direction.

The second magnetic sensors 92b output, on detecting the rotational position Py in the Yaw direction of the movable unit 10, the rotational position Py as a result of detection to the drive control unit 110. The second conversion unit 202 of the drive control unit 110 converts, on receiving the rotational position Py in the Yaw direction of the movable unit 10 from the second magnetic sensors 92b, the rotational position Py into an angle θy and outputs the angle θy to the second arithmetic element 208.

The second gyrosensor 93b outputs, on detecting the angular velocity ωy in the Yaw direction of the movable unit 10, the angular velocity ωy as the result of detection to the drive control unit 110. The second integration unit 204 of the drive control unit 110 performs, on receiving the angular velocity ωy in the Yaw direction of the movable unit 10 from the second gyrosensor 93b, integration operation on the angular velocity ωy to convert the angular velocity ωy into an angle Iωy and output the angle Iωy to the second correction unit 217.

The second acceleration sensor 93d outputs, on detecting the acceleration αy in the Yaw direction to the movable unit 10, the acceleration αy detected to the second filter unit 214. The second filter unit 214 generates a second value fαy by removing an AC component from the acceleration αy. The second filter unit 214 generates a second correction value θαy based on a first value fαp generated by the first filter unit 213 and a third value fαr generated by the third filter unit 215 and outputs the second correction value θαy to the second correction unit 217.

The second correction unit 217 corrects the angle Iωy with the second correction value θαy to obtain a second correction value (corrected angle) and output the second correction value to the second arithmetic element 208.

The second arithmetic element 208 subtracts the second correction value from the angle θy and outputs the result of subtraction to the second processing unit 211.

The second detection unit 220 decides whether or not the axis 1c is aligned with the gravitational direction to control the switch 266. If the answer is NO, the second detection unit 220 controls the switch 266 such that the arithmetic element 265 adds the result of calculation obtained by the arithmetic element 262 to the angle Iωy output from the second integration unit 204 and outputs the result (corrected angle) to the second arithmetic element 208. On the other hand, if the answer is YES, then the second detection unit 220 controls the switch 266 such that the arithmetic element 265 outputs the angle Iωy, provided by the second integration unit 204, to the second arithmetic element 208.

The second processing unit 211 subjects the result of subtraction obtained by the second arithmetic element 208 to the PID control to generate a second control signal and output the second control signal to the second driver unit 122.

The second driver unit 122 outputs the second control signal to the pair of drive coils 721, thus driving the movable unit 10 in rotation in the Yaw direction.

The third gyrosensor 401 outputs, on detecting the angular velocity ωr in the Roll direction of the movable unit 10, the angular velocity ωr as the result of detection to the drive control unit 110. The third integration unit 206 of the drive control unit 110 performs, on receiving the angular velocity ωr in the Roll direction of the movable unit 10 from the third gyrosensor 401, integration operation on the angular velocity ωr to convert the angular velocity ωr into an angle Iωr and output the angle Iωr to the third correction unit 218.

The third acceleration sensor 402 outputs, on detecting the acceleration αr in the Roll direction to the movable unit 10, the acceleration αr detected to the third filter unit 215 The third filter unit 215 generates a third value fαr by removing an AC component from the acceleration αr. The third filter unit 215 generates a third correction value θαr based on a second value fαy generated by the second filter unit 214 and a first value fαp generated by the first filter unit 213 and outputs the third correction value θαr to the third correction unit 218.

The third correction unit 218 corrects the angle Iωr with the third correction value θαr to obtain a third correction value (corrected angle) and output the third correction value to the third arithmetic element 209.

The third arithmetic element 209 subtracts the third correction value from the angle θr and outputs the result of subtraction to the third processing unit 212.

The third detection unit 221 decides whether or not the optical axis 1a is aligned with the gravitational direction to control the switch 276. If the answer is NO, the third detection unit 221 controls the switch 276 such that the arithmetic element 275 adds the result of calculation obtained by the arithmetic element 272 to the angle Iωr output from the third integration unit 206 and outputs the result (corrected angle) to the third arithmetic element 209. On the other hand, if the answer is YES, then the third detection unit 221 controls the switch 276 such that the arithmetic element 275 outputs the angle Iωr, provided by the third integration unit 206, to the third arithmetic element 209.

The third processing unit 212 subjects the result of subtraction obtained by the third arithmetic element 209 to the PID control to generate a third control signal and output the third control signal to the third driver unit 123.

The third driver unit 123 outputs the third control signal to the pair of drive coils 730 and the pair of drive coils 731, thus driving the movable unit 10 in rotation in the Roll direction.

The camera device 1 is sometimes provided such that one of the optical axis 1a, the axis 1b, or the axis 1c is aligned with the gravitational direction. For example, if the axis 1c is aligned with the gravitational direction, even driving the movable unit 10 (camera module 3) in the Yaw direction does not allow the second acceleration sensor 93d to detect the acceleration applied in the Yaw direction to the movable unit 10. If the optical axis 1a is aligned with the gravitational direction, even driving the movable unit 10 (camera module 3) in the Roll direction does not allow the third acceleration sensor 402 to detect the acceleration applied in the Roll direction to the movable unit 10. That is to say, if one of the optical axis 1a, the axis 1b, or the axis 1c is aligned with the gravitational direction, no acceleration is detected while a rotational drive is performed around that aligned axis. That is why the result of detection by the acceleration sensor that detects the direction of the rotational drive around the axis aligned with the gravitational direction needs to be removed from the control of the rotational drive of the movable unit 10. Thus, according to this embodiment, the drive control unit 110 obtains the axis aligned with the gravitational direction based on the results of detection by the first detection unit 219, the second detection unit 220, and the third detection unit 221. Then, according to this embodiment, the drive control unit 110 controls the rotational drive of the movable unit 10 with respect to the directions of rotation around the two axes, except the direction of rotation (which is one of the Pitch direction, Yaw direction, or Roll direction) around the axis aligned with the gravitational direction. This allows the actuator 2 to drive the movable unit 10 in rotation by using tilt components (tilt directions) obtained from two acceleration sensors associated with two axes, through the rotational drive around the two of the three axes, except the one axis aligned with the gravitational direction.

According to the configuration described above, the first correction value θαp is generated by the first filter unit 213. However, this is only an example and should not be construed as limiting. Alternatively, the first correction value θαp may also be generated by the first correction unit 216. Furthermore, the second correction value θαy may be generated by the second correction unit 217 and the third correction value θαr may be generated by the third correction unit 218.

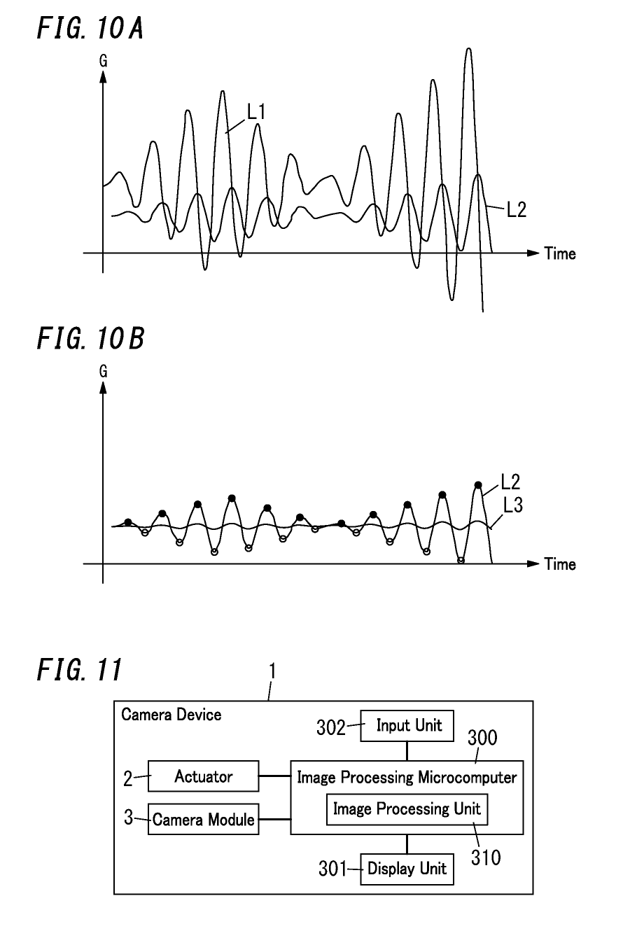

Also, in the embodiment described above, the first filter unit 213, the second filter unit 214, and the third filter unit 215 may each consist of a low-pass filter. Even in that case, the first filter unit 213, the second filter unit 214, and the third filter unit 215 are also able to remove AC components from the results of detection by the acceleration sensors. To obtain more accurate results of detection, the first filter unit 213, the second filter unit 214, and the third filter unit 215 suitably each apply a low-pass filter to the result of detection and then obtain an intermediate value between a peak value and a bottom value. The reason will be described with reference to FIGS. 10A and 10B. In FIGS. 10A and 10B, the ordinate indicates the acceleration and the abscissa indicates the time.

In FIG. 10A, the curve L1 indicates a signal representing the result of detection obtained by an acceleration sensor before its output data is passed through the low-pass filter, and the curve L2 indicates a signal representing the result of detection obtained by the acceleration sensor after its output data has been passed through the low-pass filter. Just passing the data through a low-pass filter allows AC components to be left. In contrast, the first filter unit 213, the second filter unit 214, and the third filter unit 215 according to this embodiment each obtain peak values and bottom values for a signal that has passed through the low-pass filter and then obtains intermediate values between the peak values and the bottom values. This allows AC components to be further removed (see FIG. 10B). In FIG. 10B, the solid circles indicate peak values and the open circles indicate bottom values. In FIG. 10B, the curve L3 indicates a signal representing intermediate values between the peak values and the bottom values. The AC components have been removed almost completely from the curve L3. This allows the first filter unit 213, the second filter unit 214, and the third filter unit 215 to output more accurate results of detection compared to the signal representing the data that has just been passed through the low-pass filter (indicated by the curve L2).

Alternatively, the first filter unit 213, the second filter unit 214, and the third filter unit 215 may each obtain peak values and bottom values of the results of detection by the acceleration sensors and then obtain intermediate values between the peak values and the bottom values without using any low-pass filters. Still alternatively, the first filter unit 213, the second filter unit 214, and the third filter unit 215 may also obtain intermediate values based on the results of detection by the acceleration sensors by using filters, for example. In any of these cases, the first filter unit 213, the second filter unit 214, and the third filter unit 215 are each allowed to remove AC components from the results of detection by the acceleration sensors.

In the embodiment described above, the first correction unit 216 includes the switch 256. However, this configuration is only an example and should not be construed as limiting. Alternatively, the first correction unit 216 may have no switches 256. In that case, if the first detection unit 219 finds the axis 1b aligned with the gravitational direction, the first correction unit 216 may set the value m at zero. Likewise, if the second detection unit 220 finds the axis 1c aligned with the gravitational direction, the second correction unit 217 may set the value m at zero, instead of being provided with the switch 266. In the same way, if the third detection unit 221 finds the optical axis 1a aligned with the gravitational direction, the third correction unit 218 may set the value m at zero, instead of being provided with the switch 276.

(Third Embodiment)

A camera device 1 according to a third embodiment further has the capability of automatically tracking a particular subject included in an image captured, which is a major difference from the first embodiment. A camera device 1 according to the third embodiment will be described with reference to FIGS. 11-13B. The following description of the third embodiment will be focused on the differences from the first embodiment. Also, in the following description, any constituent member of the third embodiment having the same function as a counterpart of the first embodiment described above will be designated by the same reference numeral as that counterpart's, and description thereof will be omitted herein as appropriate.

The camera device 1 of this embodiment further includes an image processing microcomputer 300, a display unit 301, and an input unit 302.

The image processing microcomputer 300 may be provided for the second printed circuit board 91, for example. The image processing microcomputer 300 performs the function of the image processing unit 310 shown in FIG. 11 by executing a program stored in the memory. In this embodiment, the program is stored in advance in the memory of the computer. Alternatively, the program may also be downloaded via a telecommunications line such as the Internet or distributed after having been stored on a storage medium such as a memory card. The image processing unit 310 will be described in detail later.

The display unit 301 may be implemented as a display device with a reduced thickness such as a liquid crystal display or an organic electroluminescent (EL) display. The display unit 301 displays the image captured by the camera module 3.

The input unit 302 has the capability of accepting the operation performed by the operator of the camera device 1. In this embodiment, the camera device 1 includes a touchscreen panel display, which performs the function of the display unit 301 and the function of the input unit 302. However, this is only an example and should not be construed as limiting. The input unit 302 does not have to be a touchscreen panel display but may also be implemented as a keyboard, a pointing device, or a mechanical switch, for example.

The operator may designate a particular subject as the object of automatic tracking by putting his or her finger on an image portion representing the particular subject on the image displayed on the display unit 301. This allows the input unit 302 to accept the particular subject, designated by touching, as the object of automatic tracking.

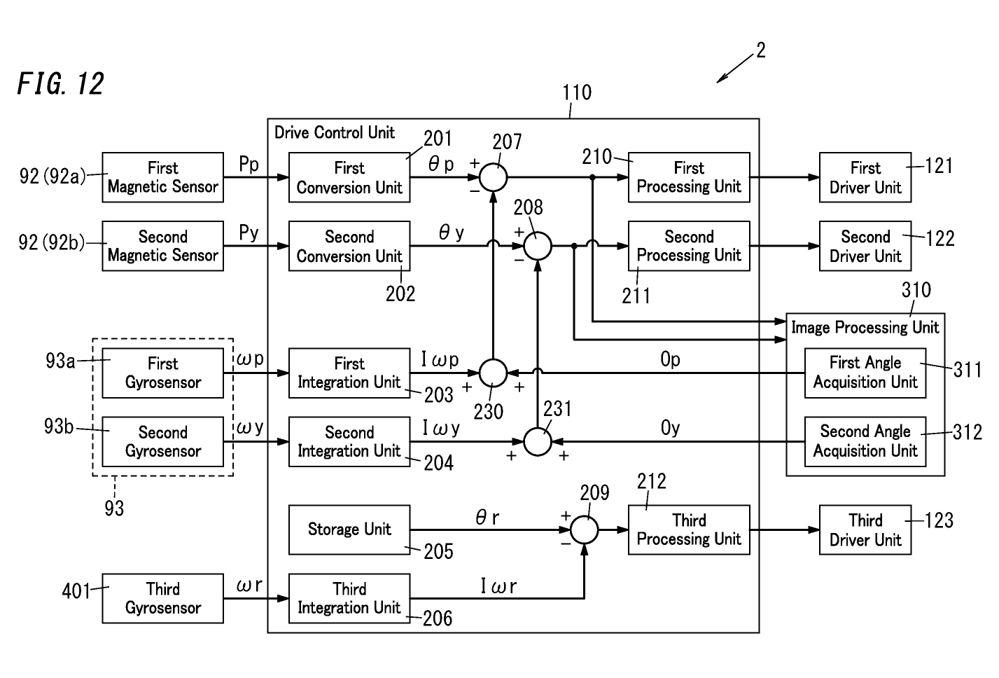

Next, the image processing unit 310 will be described. The image processing unit 310 includes a first angle acquisition unit 311 and a second angle acquisition unit 312 as shown in FIG. 12.

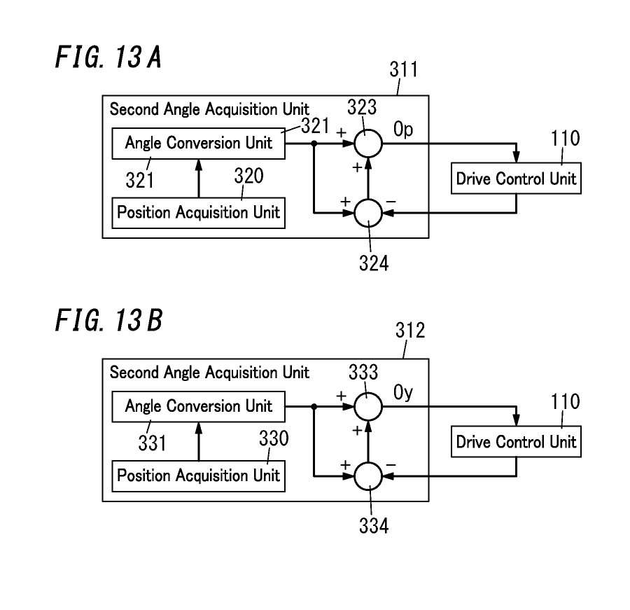

The first angle acquisition unit 311 acquires an angle in the Pitch direction between the particular subject shot in the image captured by the camera module 3 and a center (corresponding to the optical axis 1a) of the image capturing area. The first angle acquisition unit 311 includes a location acquisition unit 320, an angle conversion unit 321, and two arithmetic elements 323, 324 as shown in FIG. 13A. The location acquisition unit 320 acquires a first piece of location information of the particular subject as the object of automatic tracking by some subject recognition technique such as face recognition or object recognition. In this example, the first piece of location information may be a coordinate in the Pitch direction (hereinafter referred to as “first location coordinate”) with respect to the center of the image capturing area.

Suppose the camera module 3 has focused on the particular subject. In such a situation, the distance from the camera device 1 to the particular subject has been calculated by the image processing unit 310.

The angle conversion unit 321 obtains, based on the first piece of location information acquired by the location acquisition unit 320, a first angle in the Pitch direction between the particular subject and the center. For example, if the coordinate in the Pitch direction of the particular subject represented by the first piece of location information is y and the distance from the camera device 1 to the particular subject is L, then the first angle in the Pitch direction between the particular subject and the center is given by a tan (y/L).

The arithmetic element 323 adds the result of calculation obtained by the arithmetic element 324 to the angle obtained by the angle conversion unit 321 and outputs the result of addition to the drive control unit 110. The arithmetic element 324 subtracts the angle output from the first arithmetic element 207 of the drive control unit 110 from the angle obtained by the angle conversion unit 321 and outputs the result of subtraction.

This configuration allows the first angle acquisition unit 311 to obtain, based on the angle θp, the magnitude of deviation in the Pitch direction between the particular subject to be tracked and the center (corresponding to the optical axis 1a) of the image capturing area, and output the magnitude of correction, determined with the magnitude of deviation taken into account, to the drive control unit 110.

The second angle acquisition unit 312 acquires an angle in the Yaw direction between the particular subject shot in the image captured by the camera module 3 and a center (corresponding to the optical axis 1a) of the image capturing area. The second angle acquisition unit 312 includes a location acquisition unit 330, an angle conversion unit 331, and two arithmetic elements 333, 334 as shown in FIG. 13B. The location acquisition unit 330 acquires a second piece of location information of the particular subject as the object of automatic tracking by some subject recognition technique such as face recognition or object recognition. In this example, the second piece of location information may be a coordinate in the Yaw direction (hereinafter referred to as a “second location coordinate”) with respect to the center of the image capturing area.

The angle conversion unit 331 obtains, based on the second piece of location information acquired by the location acquisition unit 330, a second angle in the Yaw direction between the particular subject and the center. For example, if the coordinate in the Yaw direction of the particular subject represented by the second piece of location information is x and the distance from the camera device 1 to the particular subject is L, then the second angle in the Yaw direction between the particular subject and the center is given by a tan (x/L).

The arithmetic element 333 adds the result of calculation obtained by the arithmetic element 334 to the angle obtained by the angle conversion unit 331 and outputs the result of addition to the drive control unit 110. The arithmetic element 334 subtracts the angle output from the second arithmetic element 208 of the drive control unit 110 from the angle obtained by the angle conversion unit 331 and outputs the result of subtraction.

This configuration allows the second angle acquisition unit 312 to obtain, based on the angle θy, the magnitude of deviation in the Yaw direction between the particular subject to be tracked and the center (corresponding to the optical axis 1a) of the image capturing area, and output the magnitude of correction, determined with the magnitude of deviation taken into account, to the drive control unit 110.

The drive control unit 110 of this embodiment includes not only all of the functional constituent elements described for the first embodiment but also a fourth arithmetic element 230 and a fifth arithmetic element 231 as well. The fourth arithmetic element 230 adds the result of processing obtained by the first angle acquisition unit 311 of the image processing unit 310 to the result obtained by the first integration unit 203 and outputs the result of addition to the first arithmetic element 207. The fifth arithmetic element 231 adds the result of processing obtained by the second angle acquisition unit 312 of the image processing unit 310 to the result obtained by the second integration unit 204 and outputs the result of addition to the second arithmetic element 208.

Next, it will be described with reference to FIG. 12 how the camera device 1 of this embodiment operates.

The first magnetic sensors 92a detect a rotational position Pp in the Pitch direction of the movable unit 10 and output the rotational position Pp to the drive control unit 110. The first conversion unit 201 converts the rotational position Pp into an angle θp.

The first gyrosensor 93a detects the angular velocity ωp in the Pitch direction of the movable unit 10 and outputs the angular velocity ωp to the drive control unit 110. The first integration unit 203 performs integration operation on the angular velocity ωp to convert the angular velocity ωp into an angle Iωp and output the angle Iωp to the fourth arithmetic element 230.

The fourth arithmetic element 230 adds the result of calculation Op obtained by the arithmetic element 323 of the first angle acquisition unit 311 to the angle Iωp and outputs the result of addition to the first arithmetic element 207.

The first arithmetic element 207 subtracts the result of calculation obtained by the fourth arithmetic element 230 from the angle θp, and outputs the result of subtraction to the first processing unit 210 and the first angle acquisition unit 311 of the image processing unit 310. The first processing unit 210 subjects the result of subtraction obtained by the first arithmetic element 207 to the PID control to generate a first control signal and output the first control signal to the first driver unit 121. The first driver unit 121 outputs the first control signal to the pair of drive coils 720, thereby driving the movable unit 10 in rotation in the Pitch direction.

The second magnetic sensors 92b detect a rotational position Py in the Yaw direction of the movable unit 10 and output the rotational position Py to the drive control unit 110. The second conversion unit 202 converts the rotational position Py into an angle θy.

The second gyrosensor 93b detects the angular velocity ωy in the Yaw direction of the movable unit 10 and outputs the angular velocity ωy to the drive control unit 110. The second integration unit 204 performs integration operation on the angular velocity ωy to convert the angular velocity ωy into an angle Iωy and output the angle Iωy to the fifth arithmetic element 231.

The fifth arithmetic element 231 adds the result of calculation Oy obtained by the arithmetic element 333 of the second angle acquisition unit 312 to the angle Iωy and outputs the result of addition to the second arithmetic element 208.

The second arithmetic element 208 subtracts the result of calculation obtained by the fifth arithmetic element 231 from the angle θy, and outputs the result of subtraction to the second processing unit 211 and the second angle acquisition unit 312 of the image processing unit 310. The second processing unit 211 subjects the result of subtraction obtained by the second arithmetic element 208 to the PID control to generate a second control signal and output the second control signal to the second driver unit 122.

The second driver unit 122 outputs the second control signal to the pair of drive coils 721, thereby driving the movable unit 10 in rotation in the Yaw direction.

The third gyrosensor 401 detects the angular velocity ωr in the Roll direction of the movable unit 10 and outputs the angular velocity ωr to the drive control unit 110. The third integration unit 206 performs integration operation on the angular velocity ωr to convert the angular velocity ωr into an angle Iωr and output the angle Iωr to the third arithmetic element 209.

The third arithmetic element 209 subtracts the angle Iωr from information (angle θr), stored in the storage unit 205, about a reference position (predetermined position), and outputs the result of subtraction to the third processing unit 212. The third processing unit 212 subjects the result of subtraction obtained by the third arithmetic element 209 to the PID control to generate a third control signal and output the third control signal to the third driver unit 123.

The third driver unit 123 outputs the third control signal to the pair of drive coils 730 and the pair of drive coils 731, thereby driving the movable unit 10 in rotation in the Roll direction.

Suppose the particular subject is located on the left-hand side with respect to the center of the image capturing area, for example, and the angle defined in the Pitch direction by the particular subject in such a situation is θ. When the particular subject is just tracked so as to be located at the center of the image capturing area with the deviation, caused by a shake of the camera device 1, for example, not taken into account, the actuator 2 may drive the movable unit 10 (camera module 3) in rotation in the Pitch direction by −θ. However, if the camera device 1 itself has tilted by θ1 in the Pitch direction due to a camera shake or for some other reason as shown in FIG. 6A, the particular subject cannot be shifted to the center of the image capturing area by the rotational drive described above. To shift the particular subject to the center of the image capturing area, the actuator 2 needs to rotate the movable unit 10 by θ2−(θ1+θ) in the Pitch direction.

Also, suppose the particular subject is located on the right-hand side with respect to the center of the image capturing area, for example, and the angle defined in the Pitch direction by the particular subject in such a situation is θ′. When the particular subject is just tracked so as to be located at the center of the image capturing area with the deviation, caused by a shake of the camera device 1, for example, not taken into account, the actuator 2 may drive the movable unit 10 (camera module 3) in rotation in the Pitch direction by +θ. However, if the camera device 1 itself has tilted by θ1 in the Pitch direction due to a camera shake or for some other reason as shown in FIG. 6A, the particular subject cannot be shifted to the center of the image capturing area by the rotational drive described above. To shift the particular subject to the center of the image capturing area, the actuator 2 needs to rotate the movable unit 10 by θ2−(θ1+(−θ′)) in the Pitch direction. In this example, the angle in the Pitch direction when the particular subject is located on the right-hand side with respect to the center of the image capturing area is supposed to be a negative value, and the angle in the Pitch direction when the particular subject is located on the left-hand side with respect to the center of the image capturing area is supposed to be a positive value.

Likewise, in the Yaw direction, the particular subject may also be shifted to the center of the image capturing area based on the result obtained by subtracting the sum of the angle obtained from the result of detection by the second gyrosensor 93b and the angle defined in the Yaw direction by the particular subject from the result of detection by the second magnetic sensors 92b.

That is to say, the camera device 1 of this embodiment is able to drive the movable unit 10 (camera module 3) in rotation in the Pitch direction by using, as an offset value, the angle defined in the Pitch direction by the particular subject and provided by the image processing unit 310. In addition, the camera device 1 of this embodiment is also able to drive the movable unit 10 (camera module 3) in rotation in the Yaw direction by using, as an offset value, the angle defined in the Yaw direction by the particular subject and provided by the image processing unit 310. Thus, the camera device 1 of this embodiment is allowed to track the particular subject such that the particular subject is located at the center of the image capturing area.

In the embodiment described above, the camera device 1 includes the display unit 301 and the input unit 302, and is configured to display the image captured by the camera module 3 and accept the designation of a particular subject. However, this is only an example and should not be construed as limiting. Alternatively, the camera device 1 may also be configured to transmit a captured image either wirelessly or via a cable to a telecommunications device including the display unit 301 and the input unit 302. Examples of the telecommunications devices include general-purpose computers, tablet computers, cellphones, and smartphones. In that case, the telecommunications device makes the display unit 301 display the image transmitted from the camera device 1 and accepts the designation of a particular subject as the object of tracking. The telecommunications device obtains first and second pieces of location information about the particular subject from the area where the image is displayed on the display unit 301, i.e., from the image capturing area, and transmits these pieces of location information to the camera device 1. The camera device 1 obtains, based on the first and second pieces of location information, the angle in the Pitch direction and the angle in the Yaw direction between the particular subject and the center of the image capturing area (point corresponding with the optical axis 1a). After that, the camera device 1 operates just as described above, and description thereof will be omitted herein. Thus, the operator of the telecommunications device is allowed to make the camera device 1 track the particular subject even at a location distant from the camera device 1.

Alternatively, the camera device 1 may transmit the captured image either wirelessly or via a cable to an external device. As used herein, the “external device” refers to a device configured to transmit an instruction to drive the movable unit 10 in rotation and having the display unit 301. The operator of the external device is allowed to instruct, while viewing the image displayed on the display unit 301, driving the movable unit 10 in rotation such that the particular subject as the object of tracking is aligned with the optical axis 1a.

Optionally, the first angle acquisition unit 311 and the second angle acquisition unit 312 described for this embodiment may be included in the drive control unit 110. In that case, the image processing unit 310 outputs the image captured to the drive control unit 110.

Also, the automatic tracking capability described for this embodiment is applicable to the camera device 1 of the second embodiment as well.

(Variations)

Next, variations will be enumerated one after another. Note that any of the variations to be described below may be combined with any of the embodiments described above as appropriate.

In the embodiments described above, a configuration in which the sensor chip 93 is provided for the fixed unit 20 is adopted. However, this configuration is only an example and should not be construed as limiting. Alternatively, the sensor chip 93 may also be provided for the movable unit 10. That is to say, in the first and third embodiments, the first gyrosensor 93a and the second gyrosensor 93b may be provided for the movable unit 10. Also, in the second embodiment, the first gyrosensor 93a, the second gyrosensor 93b, the first acceleration sensor 93c, and the second acceleration sensor 93d may be provided for the movable unit 10.

The sensor chip 93 may be provided for movable unit 10 or the fixed unit 20, whichever appropriate.

Providing the sensor chip 93 for the movable unit 10 allows the tilt of the camera module 3 to be detected directly. This achieves the advantage of detecting the tilt of the camera module 3 more accurately.

On the other hand, when the sensor chip 93 is provided for the fixed unit 20, the tilt of the camera device 1 itself is detected as the tilt of the movable unit 10 (camera module 3). Thus, providing the sensor chip 93 for the fixed unit 20 would be effective at controlling the camera device 1 as a whole.

In the embodiments described above, the actuator 2 is applied to the camera device 1. However, this is only an example and should not be construed as limiting. Alternatively, the actuator 2 is also applicable to laser pointers, light fixtures, projectors, and various other devices.

In the embodiments described above, the actuator 2 includes magnetic sensors 92 (including the first magnetic sensors 92a and the second magnetic sensors 92b) to detect the rotational position of the movable unit 10 with respect to the fixed unit 20. However, this is only an example and should not be construed as limiting. The actuator 2 may also be configured such that the fixed unit 20 includes a sensor with the ability to detect the rotational position of the movable unit 10 with respect to the fixed unit 20. For example, a laser diode may be mounted on the bottom of the movable unit 10 and a photodetector may be provided for the fixed unit 20. In that case, the photodetector receives an optical signal, output from the laser diode, to detect the rotational position of the movable unit 10.

(Resume)

As can be seen from the foregoing description, an actuator (2) according to a first aspect includes a movable unit (10), a fixed unit (20), a first driving unit (30a), a second driving unit (30b), and a third driving unit (30c). The actuator (2) further includes a first position detecting unit (such as first magnetic sensors 92a), a second position detecting unit (such as second magnetic sensors 92b), a first gyrosensor (93a), a second gyrosensor (93b), a third gyrosensor (401), and a drive control unit (110). The fixed unit (20) holds the movable unit (10) so as to allow the movable unit (10) to rotate in Pitch direction, Yaw direction, and Roll direction, respectively, around a first axis (such as an axis 1b), a second axis (such as an axis 1c), and a third axis (such as an axis 1a) that are perpendicular to each other. The first position detecting unit and the second position detecting unit are provided for the fixed unit (20). The third gyrosensor (401) is provided for the movable unit (10). The drive control unit (110) controls rotation in the Pitch direction of the movable unit (10) by controlling the first driving unit (30a) in accordance with results of detection by the first position detecting unit and the first gyrosensor (93a). The drive control unit (110) also controls rotation in the Yaw direction of the movable unit (10) by controlling the second driving unit (30b) in accordance with results of detection by the second position detecting unit and the second gyrosensor (93b). The drive control unit (110) further controls rotation in the Roll direction of the movable unit (10) by controlling the third driving unit (30c) in accordance with a result of detection by the third gyrosensor (401).

According to this configuration, the actuator (2) uses the third gyrosensor (401) to detect the angle of rotation in the Roll direction. This allows the actuator (2) to control the rotational drive of the movable unit (10) in the three directions (namely, the Pitch direction, Yaw direction, and Roll direction) with respect to the fixed unit (20) while reducing the number of parts required to detect the angle of rotation in the Roll direction.

In an actuator (2) according to a second aspect, which may be implemented in conjunction with the first aspect, the first gyrosensor (93a) and the second gyrosensor (93b) are provided for the fixed unit (20). According to this configuration, the actuator (2) detects the tilt of the camera device (1) itself as the tilt of the movable unit (10) (camera module 3). Thus, providing the sensor chip (93) for the fixed unit (20) is effective in controlling the camera device (1) as a whole.

In an actuator (2) according to a third aspect, which may be implemented in conjunction with the first aspect, the first gyrosensor (93a) and the second gyrosensor (93b) are provided for the movable unit (10). According to this configuration, the actuator (2) detects the tilt of the camera module (3) directly. This allows the actuator (2) to detect the tilt of the camera module (3) more accurately.

In an actuator (2) according to a fourth aspect, which may be implemented in conjunction with any one of the first to third aspects, the drive control unit (110) controls the first driving unit (30a) in accordance with results of detection by the first gyrosensor (93a) and the first magnetic sensors (92a) such that the rotational position in the Pitch direction of the movable unit (10) corresponds with a predetermined position in the Pitch direction. The drive control unit (110) also controls the second driving unit (30b) in accordance with results of detection by the second gyrosensor (93b) and the second magnetic sensors (92b) such that the rotational position in the Yaw direction of the movable unit (10) corresponds with a predetermined position in the Yaw direction. The drive control unit (110) further controls the third driving unit (30c) such that the rotational position in the Roll direction of the movable unit corresponds with a predetermined position in the Roll direction. This configuration allows the actuator (2) to drive the movable unit (10) in rotation in respective predetermined positions in the Pitch, Yaw, and Roll directions in accordance with respective angles of rotation in the Pitch, Yaw, and Roll directions.

In an actuator (2) according to a fifth aspect, which may be implemented in conjunction with the fourth aspect, the drive control unit (110) subtracts an angle of rotation (angle Iωp) in the Pitch direction of the movable unit (10) from an angle of rotation (angle θp) obtained from a rotational position in the Pitch direction to obtain a first differential value for the Pitch direction. The drive control unit (110) also subtracts an angle of rotation (angle Iωy) in the Yaw direction of the movable unit (10) from an angle of rotation (angle θy) obtained from a rotational position in the Yaw direction to obtain a second differential value for the Yaw direction. The drive control unit (110) further subtracts an angle of rotation (angle Iωr) in the Roll direction of the movable unit (10) from an angle of rotation (angle θr) defined by the predetermined position in the Roll direction to obtain a third differential value. The drive control unit (110) controls the first driving unit (30a), the second driving unit (30b), and the third driving unit (30c) in accordance with the first differential value, the second differential value, and the third differential value, respectively. This configuration allows the actuator (2) to calculate respective angles to drive the movable unit (10) in rotation in the Pitch, Yaw, and Roll directions.

An actuator (2) according to a sixth aspect, which may be implemented in conjunction with the fifth aspect, further includes a first acceleration sensor (93c), a second acceleration sensor (93d), and a third acceleration sensor (402). In accordance with a first tilt component (first tilt direction) and a second tilt component (second tilt direction) respectively obtained from results of detection by two acceleration sensors associated with two directions, the drive control unit (110) controls two driving units corresponding to the two directions. The two directions are two out of the Pitch, Yaw, and Roll directions, other than one of the Pitch, Yaw, or Roll direction, of which an axis defining a center of rotation agrees with a gravitational direction. This configuration allows the actuator (2) to drive the movable unit (10) in rotation more accurately by excluding the result of detection by an acceleration sensor with the ability to detect the acceleration in one direction that corresponds with the gravitational direction.

In an actuator (2) according to a seventh aspect, which may be implemented in conjunction with the sixth aspect, the drive control unit (110) calculates a first tilt angle based on the first tilt component and a third tilt component (third tilt direction), obtained based on a result of detection by an acceleration sensor, provided for the one direction, of which the axis defining the center of rotation agrees with the gravitational direction. The drive control unit (110) also calculates a second tilt angle based on the second tilt component and the third tilt component (third tilt direction). The drive control unit (110) also performs subtraction of a first calculation result from the first tilt angle, obtains a first correction value based on a result of the subtraction, and adds the first correction value to the first calculation result, to obtain an angle of rotation in a first direction of the movable unit (10). The first calculation result is an integral of angular velocities detected by one gyrosensor, associated with a direction (the first direction) corresponding to an acceleration sensor that has obtained the first tilt component. The drive control unit (110) further performs subtraction of a second calculation result from the second tilt angle, obtains a second correction value based on a result of the subtraction, and adds the second correction value to the second calculation result, to obtain an angle of rotation in a second direction of the movable unit (10). The second calculation result is an integral of angular velocities detected by one gyrosensor, associated with a direction (the second direction) corresponding to an acceleration sensor that has obtained the second tilt component.

This configuration allows the actuator (2) to correct, based on a tilt angle obtained from a result of detection by the acceleration sensor, the result of detection by the gyrosensor.

In an actuator (2) according to an eighth aspect, which may be implemented in conjunction with the seventh aspect, the drive control unit (110) obtains the first tilt component, the second tilt component, and the third tilt component by subjecting signals, representing respective results of detection obtained by, and output from, the first acceleration sensor (93c), the second acceleration sensor (93d), and the third acceleration sensor (402), to averaging processing. According to this configuration, the actuator (2) removes AC components from the results of detection by the first acceleration sensor (93c), the second acceleration sensor (93d), and the third acceleration sensor (402). This allows the actuator (2) to obtain more accurate tilt components (tilt directions) in the respective directions.

In an actuator (2) according to a ninth aspect, which may be implemented in conjunction with any one of the first to eighth aspects, the movable unit (10) includes a pair of first driving magnets (620) and a pair of second driving magnets (621). The fixed unit (20) includes a pair of first magnetic yokes (710) facing the pair of first driving magnets (620) and a pair of second magnetic yokes (711) facing the pair of second driving magnets (621). The pair of first magnetic yokes (710) are provided with a pair of first drive coils (such as drive coils 720). The pair of second magnetic yokes (711) are provided with a pair of second drive coils (such as drive coils 721). The pair of first magnetic yokes (710) are provided with a pair of third drive coils (such as drive coils 730). The pair of second magnetic yokes (711) are provided with a pair of fourth drive coils (such as drive coils 731). The first driving unit (30a) is made up of the pair of first driving magnets (620), the pair of first magnetic yokes (710), and the pair of first drive coils. The second driving unit (30b) is made up of the pair of second driving magnets (621), the pair of second magnetic yokes (711), and the pair of second drive coils. The third driving unit (30c) is made up of the pair of first driving magnets (620), the pair of second driving magnets (621), the pair of first magnetic yokes (710), the pair of second magnetic yokes (711), the pair of third drive coils, and the pair of fourth drive coils. This configuration allows the actuator (2) to electromagnetically drive the movable unit (10) in rotation in the three directions.

A camera device (1) according to a tenth aspect includes the actuator (2) of any one of the first to ninth aspects; and a camera module (3) as the object to be driven. This configuration allows the camera device (1) to more accurately detect the tilts in the Pitch, Yaw, and Roll directions of the camera module (3). In addition, driving the movable unit (10) (camera module 3) in rotation based on the tilts detected allows the camera shake to be compensated for. Besides, this also allows the camera device (1) to control the rotational drive of the movable unit (10) in the three directions (namely, the Pitch, Yaw, and Roll directions) with respect to the fixed unit (20) while reducing the number of parts required to detect the angle of rotation in the Roll direction.

A camera device (1) according to an eleventh aspect, which may be implemented in conjunction with the tenth aspect, further includes an image processing unit (310). The image processing unit (310) calculates a first angle in the Pitch direction of a particular subject, included in the image, with respect to a center of an image capturing area, and also calculates a second angle in the Yaw direction with respect to the center of the image capturing area. The drive control unit (110) controls the first driving unit (30a) based on results of detection by the first position detecting unit and the first gyrosensor (93a) and based on the first angle such that the particular subject is located at the center of the image capturing area. The drive control unit (110) also controls the second driving unit (30b) based on results of detection by the second position detecting unit and the second gyrosensor (93b) and based on the second angle. According to this configuration, the camera device (1) drives the movable unit (10) (camera module 3) in rotation such that a particular subject is located at the center of the image capturing area. This allows the camera device (1) to track the particular object automatically.

1. An actuator comprising:
a holder configured to hold an object to be driven thereon;
a fixed holder configured to hold the holder so as to allow the holder to rotate around each of a first axis, a second axis, and a third axis that are perpendicular to each other;
a first drive configured to drive the holder in rotation in Pitch direction around the first axis;
a second drive configured to drive the holder in rotation in Yaw direction around the second axis;
a third drive configured to drive the holder in rotation in Roll direction around the third axis;
a first position detector provided for the fixed holder and configured to detect a rotational position in the Pitch direction of the holder with respect to the fixed holder;
a second position detector provided for the fixed holder and configured to detect a rotational position in the Yaw direction of the holder with respect to the fixed holder;
a first gyrosensor configured to detect an angular velocity in the Pitch direction of the holder;
a second gyrosensor configured to detect an angular velocity in the Yaw direction of the holder;
a third gyrosensor provided for the holder and configured to detect an angular velocity in the Roll direction of the holder; and
a drive controller configured to control rotation of the holder by controlling the first drive in accordance with results of detection by the first position detector and the first gyrosensor, controlling the second drive in accordance with results of detection by the second position detector and the second gyrosensor, and controlling the third drive in accordance with a result of detection by the third gyrosensor.

2. The actuator of claim 1, wherein
the first gyrosensor and the second gyrosensor are provided for the fixed holder.

3. The actuator of claim 1, wherein
the first gyrosensor and the second gyrosensor are provided for the holder.

4. The actuator of claim 1, wherein
the drive controller is configured to:
control the first drive in accordance with a result of detection by the first gyrosensor such that the rotational position in the Pitch direction, obtained based on a result of detection by the first position detector, of the holder corresponds with a predetermined position in the Pitch direction;
control the second drive in accordance with a result of detection by the second gyrosensor such that the rotational position in the Yaw direction, obtained based on a result of detection by the second position detector, of the holder corresponds with a predetermined position in the Yaw direction; and
control the third drive such that the rotational position in the Roll direction, obtained based on a result of detection by the third gyrosensor, of the holder corresponds with a predetermined position in the Roll direction.

5. The actuator of claim 4, wherein
the drive controller is configured to:
perform integration of the angular velocities detected by the first gyrosensor, obtain, based on a result of the integration, a first angle of rotation that is an angle of rotation in the Pitch direction of the holder, and subtract the first angle of rotation from an angle of rotation obtained from a rotational position in the Pitch direction, detected by the first position detector, to obtain a first differential value for the Pitch direction;
perform integration of the angular velocities detected by the second gyrosensor, obtain, based on a result of the integration, a second angle of rotation that is an angle of rotation in the Yaw direction of the holder, and subtract the second angle of rotation from an angle of rotation obtained from a rotational position in the Yaw direction, detected by the second position detector, to obtain a second differential value for the Yaw direction;
perform integration of the angular velocities detected by the third gyrosensor, obtain, based on a result of the integration, a third angle of rotation that is an angle of rotation in the Roll direction of the holder, and subtract the third angle of rotation from an angle of rotation defined by the predetermined position in the Roll direction to obtain a third differential value; and
control the first drive, the second drive, and the third drive in accordance with the first differential value, the second differential value, and the third differential value, respectively.

6. The actuator of claim 5, further comprising:
a first acceleration sensor configured to detect acceleration applied in the Pitch direction to the holder;
a second acceleration sensor configured to detect acceleration applied in the Yaw direction to the holder; and
a third acceleration sensor provided for the holder and configured to detect acceleration applied in the Roll direction to the holder, wherein
the drive controller is configured to, in accordance with a first tilt component and a second tilt component respectively obtained from results of detection by two acceleration sensors associated with two directions, control two, corresponding to the two directions, of the first drive, the second drive, and the third drive, the two directions being two out of the Pitch, Yaw, and Roll directions, other than one of the Pitch, Yaw, or Roll direction, of which an axis defining a center of rotation agrees with a gravitational direction.

7. The actuator of claim 6, wherein
the drive controller is configured to:
calculate a first tilt angle based on the first tilt component and a third tilt component, obtained based on a result of detection by an acceleration sensor, provided for the one of the Pitch, Yaw, or Roll direction of which the axis defining the center of rotation agrees with the gravitational direction, and also calculate a second tilt angle based on the second tilt component and the third tilt component;
perform subtraction of a first calculation result from the first tilt angle, obtain a first correction value based on a result of the subtraction, and add the first correction value to the first calculation result, to obtain an angle of rotation in a first direction of the holder, the first calculation result being an integral of angular velocities detected by one gyrosensor, associated with the first direction corresponding to an acceleration sensor that has obtained the first tilt component, out of the first gyrosensor, the second gyrosensor, and the third gyrosensor; and
perform subtraction of a second calculation result from the second tilt angle, obtain a second correction value based on a result of the subtraction, and add the second correction value to the second calculation result, to obtain an angle of rotation in a second direction of the holder, the second calculation result being an integral of angular velocities detected by one gyrosensor, associated with the second direction corresponding to an acceleration sensor that has obtained the second tilt component, out of the first gyrosensor, the second gyrosensor, and the third gyrosensor.

8. The actuator of claim 7, wherein
the drive controller is configured to obtain the first tilt component, the second tilt component, and the third tilt component by subjecting signals, representing respective results of detection obtained by, and output from, the first acceleration sensor, the second acceleration sensor, and the third acceleration sensor, to averaging processing.

9. The actuator of claim 1, wherein
the holder includes a pair of first driving magnets and a pair of second driving magnets,
the fixed holder includes a pair of first magnetic yokes facing the pair of first driving magnets and a pair of second magnetic yokes facing the pair of second driving magnets,
the pair of first magnetic yokes are provided with a pair of first drive coils formed by winding conductive wires around the pair of first magnetic yokes, respectively, to drive the pair of first driving magnets in rotation in the Pitch direction,
the pair of second magnetic yokes are provided with a pair of second drive coils formed by winding conductive wires around the pair of second magnetic yokes, respectively, to drive the pair of second driving magnets in rotation in the Yaw direction,
the pair of first magnetic yokes are provided with a pair of third drive coils formed by winding conductive wires around the pair of first magnetic yokes, respectively, to drive the pair of first driving magnets in rotation in the Roll direction,
the pair of second magnetic yokes are provided with a pair of fourth drive coils formed by winding conductive wires around the pair of second magnetic yokes, respectively, to drive the pair of second driving magnets in rotation in the Roll direction,
the first drive is comprised of the pair of first driving magnets, the pair of first magnetic yokes, and the pair of first drive coils,
the second drive is comprised of the pair of second driving magnets, the pair of second magnetic yokes, and the pair of second drive coils, and
the third drive is comprised of the pair of first driving magnets, the pair of second driving magnets, the pair of first magnetic yokes, the pair of second magnetic yokes, the pair of third drive coils, and the pair of fourth drive coils.

10. A camera device comprising:
the actuator of claim 1; and
a camera module as the object to be driven.

11. The camera device of claim 10, further comprising
an image processor configured to calculate, with a center of an image capturing area of an image captured by the camera module defined as a reference, a first angle from the center of the image capturing area based on a first location coordinate in the Pitch direction of a particular subject included in the image and also calculate a second angle from the center of the image capturing area based on a second location coordinate in the Yaw direction, wherein
the drive controller is configured to control the first drive based on results of detection by the first position detector and the first gyrosensor and based on the first angle obtained by the image processor and control the second drive based on results of detection by the second position detector and the second gyrosensor and based on the second angle obtained by the image processor such that the particular subject is located at the center.
